(19) United States
(12) Patent Application Publication
(10) Pub. No.: US 2020/0257503 A1
(43) Pub. Date: Aug. 13, 2020

(54) Auto-Programming for General Purposes and Auto-Programming Operating Systems

(71) Applicants: Juyang Weng, Okemos, MI (US); Zejia Zheng, San Mateo, MI (US); Xiang Wu, Nanking (CN); Juan Castro-Garcia, Lansing, MI (US); Shengjie Zhu, East Lansing, MI (US)

(72) Inventors: Juyang Weng, Okemos, MI (US); Zejia Zheng, San Mateo, MI (US); Xiang Wu, Nanking (CN); Juan Castro-Garcia, Lansing, MI (US); Shengjie Zhu, East Lansing, MI (US)

(73) Assignee: Juyang Weng, Okemos, MI (US)

(21) Appl. No.: 16/270,553

(22) Filed: Feb. 7, 2019

(51) Int. Cl. G06F 8/30; G06N 3/04; G06N 3/08; G06F 17/28

(52) U.S. Cl. CPC G06F 8/30; G06F 17/28; G06N 3/08; G06N 3/04

(57) ABSTRACT

This invention presents a method and an apparatus for auto-programming for general purposes as well as a new kind of operating system that uses a general-purpose learning engine to learn any open-ended practical tasks or applications. Experimental systems of the method are applied to vision, audition, and natural language understanding.

### BACKGROUND OF THE INVENTION

It remains elusive how a biological brain represents, computes, learns, memorizes, updates, and abstracts through its life-long experience—from a zygote, to embryo, fetus, newborn, infancy, childhood, and adulthood. Gradually, the brain produces behaviors that are increasingly rule-like [83], [10], [111] and can perform auto-programming for general purposes. By auto-programming, we mean that a brain automatically generates a sequence of procedures, from tying shoelaces, to making a business plan, to writing a computer program. Such programs are not just random shufflers. They must relate to meanings of the world—namely physics gives rise to meanings [36], [76].

Here, we greatly simplify such rich processes of co-development of brain and body through activities, assisted by innate (i.e., prenatally developed) reflexes and innate motivations [6], [66], to realize auto-programming from facts, education, engineering, thinking, fiction, and discovery. We ask only: What is a minimal set of mechanisms that enables a biological or silicon machine to learn auto-programming for general purposes? Some early examples from an answer below are in a companion report.

Three conceptual steps guide us to reach this answer. We first extend Finite Automata (FAs) [41], [68] to agents in the sense that states are not hidden but are open as actions. Then we extend such agent FAs to attentive agent FAs, so that the machines can automatically attend only a subset of current inputs (e.g., some words among all words on this page). Finally we introduce the GENISAMA™ by replacing all symbols in such attentive agent FAs with patterns that naturally emerge from the real world.

The remainder of the report is organized as follows: Section II introduces the theory of auto-programming for general purposes. Section III discusses details of the theory. Section IV presents the devices for auto-programming. The AOS is presented in Section V.

### BRIEF SUMMARY OF THE INVENTION

The Universal Turing Machine (TM) is a model for VonNeumann computers—general-purpose computers. A human brain can inside-skull-automatically learn a universal TM so that he acts as a general-purpose computer and writes a computer program for any practical purposes. It is unknown whether a machine can accomplish the same. This theoretical work shows how the Developmental Network (DN) can accomplish this. Unlike a traditional TM, the TM learned by DN is a super TM—Grounded, Emergent, Natural, Incremental, Skulled, Attentive, Motivated, and Abstractive (GENISAMA). A DN is free of any central controller (e.g., Master Map, convolution, or error back-propagation). Its learning from a teacher TM is one transition observation at a time, immediate, and error-free until all its neurons have been initialized by early observed teacher transitions. From that point on, the DN is no longer error-free but is always optimal at every time instance in the sense of maximal likelihood, conditioned on its limited computational resources and the learning experience. In this report, we present methods and devices for auto-programming for general purposes, and auto-programming OS (AOS) that is a new kind of OS meant to serve fully-automatic learning within the “skull” on many computers.

### I. BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A-1C. Three categories of agents. FIG. 1A: Universal Turing Machines that are symbolic and cannot auto-program, FIG. 1B: Grounded Symbolic Machines that are task-specific and cannot auto-program, and FIG. 1C: GENISAMA Universal Turing Machines whose Developmental Program are task-nonspecific. GENISAMA Universal Turing Machines can auto-program for general purposes. The tape in FIG. 1A becomes the real world and all the symbols in FIG. 1A and FIG. 1B become natural patterns. DP: Developmental Program. X: the sensory port. Z: the effector port. Y: the hidden “bridge for “banks” X and Z. Pink block: human handcrafted. Yellow blocks: emerge automatically.

FIG. 2A-2B. The architecture of DN related to the brain lobes. FIG. 2A: Each feature neuron has six fields in general. FIG. 2B: The resulting self-wired architecture of DN with Occipital, Temporal, Parietal, and Frontal lobes.

FIG. 3. Conceptual comparison between FIG. 3A the Developmental Network (DN) and FIG. 3B a symbolic network.

FIG. 4. A task-specific and modality-specific example of how a task-nonspecific and modality-nonspecific engine learns through time.

FIG. 5A-5F. Why vision requires autonomous actions.

FIG. 6. Training, regular testing, and blind-folded testing sessions conducted on campus of Michigan State University (MSU), under different times of day and different natural lighting conditions (see extensive shadows in FIG. 4). Disjoint testing sessions were conducted along paths that the machine has not learned.

FIG. 7. The sequences of concept 1 (dense, bottom) and concept 2 (sparse, top) for phonemeum/u:/.

FIG. 8. The finite automaton for the English and French versions of some sentences. The DN learned a much larger finite automaton. Cross-language meanings of partial- and full-sentences are represented by the same state of meaning context qᵢ, i=0, 1, 2, . . . , 24. See, e.g., q₁, q³, q₄, and q₅. But the language specific context is represented by another concept: language type. The last letter is the return character that indicates the end of a sentence.

FIG. 9. The relation among DN, AOS, traditional OS, hardware (computational resources, sensors and effectors), and the physical extra-body environment. The body includes DN, AOS, traditional OS, and hardware.

### DETAILED DESCRIPTION OF THE INVENTION

### II. Theory

The following, we use automata to explain the theory.

Agent FA: Two variants of FA, Moore machines and Mealy machines [41], [68] output actions but not their states. We extend an FA to agent [94], called Agent FA, by simply requiring it to output its current state entirely, but its current actions are included in the current state. This extension is conceptually important because the current state is now teachable as actions so that we are ready to address the issue of internal representations in neural networks below. In psychology, all skills and knowledge fall into two categories [110], declarative (e.g., verbal) and non-declarative (e.g., bike riding). Therefore, all skills and knowledge can be expressed as actions.

Attentive Agent FA: Suppose that a symbolic street scene at time t has multiple objects. E.g.,

S(t)={car1, car2, sign1, sign2, pedestrian1, . . . }

Instead of taking only one input symbol σ at a time (e.g.,σ=car1), an attentive agent FA attends to a set of symbols at a time (e.g., s(t)={car1, pedestrian1} ⊂S(t)). The control of any TM is an Attentive Agent FA as we will discuss below.

In order to understand auto-programming for general purposes, we need to first discuss the Universal TM [117], [41], [68].

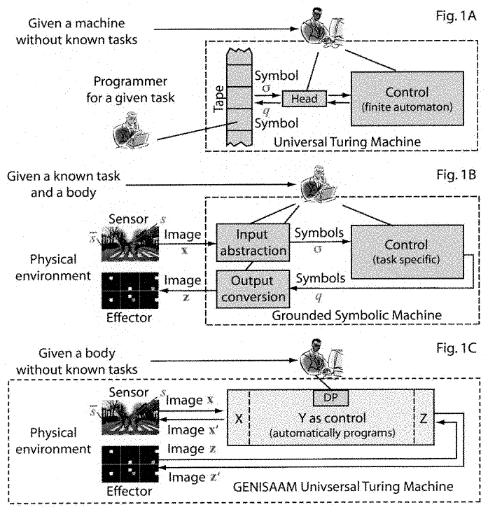

Recently, it has been proved [131] that the control of any TM is an FA as illustrated in FIG. 1A. Using this new result, our examples in Methods are much simpler.

Theorem 1: The control of a TM is not only an Agent FA, but also an Attentive Agent FA.

The proof is in Methods.

A Universal TM is for general purposes [41], [68]. The input tape of a Universal TM has two parts, the program as instructions and the data for the program to use, not just data like a regular TM. Theorem 1 is also true for any Universal TM because it is a special kind of TM.

Because the input is a set of symbols instead of a symbol, the transition table of an Attentive Agent FA, especially as the control of a Universal TM, is typically extremely large—impractical to handcraft.

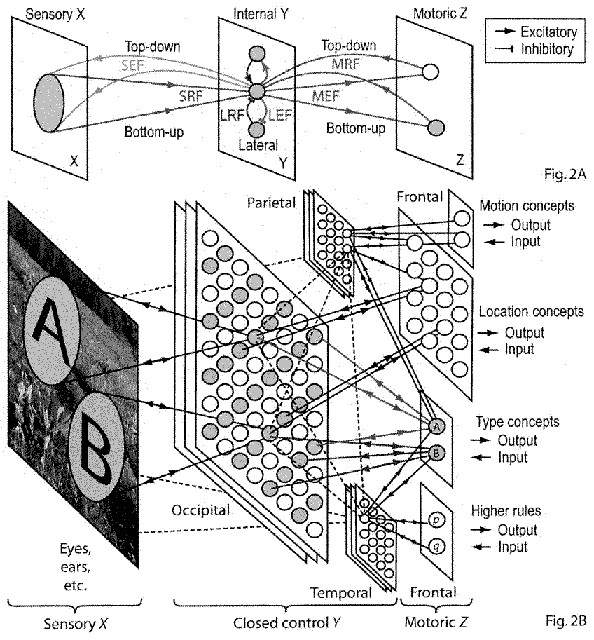

Next, we drop symbols altogether for our machine. Why? A symbol is atomic, whose meanings are in the programmer's document, not told to the symbolic TM. They are also too static for real-time tasks. Suppose you, assisted by a symbolic TM, drive into a new country that uses a new language (e.g., new signs) but the programmer of your symbolic TM has not considered this new language. Your biological brain immediately deals with the patterns (e.g., images) of new signs directly without the programmer's document because you can pull your car over and start to learn. Namely, your brain starts to auto-reprogram itself. But your symbolic TM in FIG. 2B cannot because all its symbols are static and your programmer has left you! Weng [128] proved that your brain is free of symbols for a complexity reason.

FIG. 2A-2B shows the architecture of DN related to the brain lobes. The internal brain Y is theoretically modeled as the two-way bridge of the sensory bank X and the motor bank Z. The bridge, mathematically denoted by Eq. (3), is extremely rich: Self-wiring within a Developmental Network (DN) as the control of GENISAMA TM, based on statistics of activities through “lifetime”, without any central controller, Master Map, handcrafted features, and convolution. FIG. 2A illustrates that each feature neuron has six fields in general. S: Sensory; M: motoric; L: lateral; R: receptive; E: effective; F: field. But simulated neurons in X do not have Sensory Receptive Field (SRF) and Sensory Effective Field (SEF) because they only effect Y and those in Z do not have Motor Receptive Field (MRF) and Motoric Effective Field (MEF) because they only receive from Y. FIG. 2B outlines the resulting self-wired architecture of DN with Occipital, Temporal, Parietal, and Frontal lobes. Regulated by a general-purpose Developmental Program (DP), the DN self-wires by “living” in the physical world. The X and Z areas are supervised by physics, including self, teachers, and other physical events. Through the synaptic maintenance [123], [35], some Y neurons gradually lost their early connections (dashed lines) with X (Z) areas and become “later” (early) Y areas. In the (later) Parietal and Temporal lobes, some neurons further gradually lost their connections with the (early) Occipital area and become rule-like neurons. These self-wired connections give rise to a complex dynamic network, with shallow and deep connections instead of a deep cascade of areas. Object location and motion are non-declarative concepts and object type and language sequence are declarative concepts [110]. Concepts and rules are abstract with the desired specificities and invariances. See Methods for why DN does not have any static Brodmann areas.

For auto-programming, we need a new theory that uses exclusively natural patterns (e.g., image patches of cars and signs). The six necessary conditions are in the acronym GENISAMA below.

GENISAMA TM: As illustrated in FIG. 1C it has a Developmental Network (DN) as its control and the real (physical) world as its “tape”. The DN has three areas, sensory X, hidden Y and motoric Z with details shown in FIG. 2A-2B. We also use X, Y, Z to denote the spaces, respectively, of the corresponding neuronal response patterns.

If X and Z contain all sensors and effectors of an agent, Y models the entire hidden “brain”. If X and Z correspond to a subpart of the brain areas, Y models the brain area that connect X and Z as a two-way “bridge”. The computational meanings of the acronym GENISAMA are as follows:

Grounded: All patterns z∈Z and x∈X are from the external environment (i.e., the body and the extra-body world), not from any symbolic tape.

Emergent: All patterns z∈Z and x∈X emerge from activities (e.g., images). All vectors y∈Y emerge automatically from z∈Z and x∈X.

Natural: All patterns z∈Z and x∈X are natural from real sensors and real effectors, without using any task-specific encoding, as illustrated in FIG. 2A-2B.

Incremental: The machine incrementally updates at times t=1, 2, . . . . Namely DN uses (z(t), x(t)) for update the network and discard it before taking the next (z(t+1), x(t+1)). We avoid storing images for offline batch training (e.g., as in ImageNet) because the next image x(t+1) is unavailable without first generating and executing the agent action z(t) which typically alters the scene that determines x(t+1).

Skulled: As the skull closes the brain to the environment, everything inside the Y area (neurons and connections) are initialized at t=0 and off limit to environment's direct manipulation after t=0.

Attentive: In every cluttered sensory image x∈X only the attended parts correspond to the current attended symbol set s. New here is the attention to cluttered motor image z∈Z so that the attended parts correspond to the current state symbol q (e.g., firing muscle neurons in the mouth and arms). Two symbols correspond to a pattern (not necessarily connected, as in s={car2, pedestrian)}). Note: The attention here for x is about the cluttered sensory world, consistent with the literature [75], [79], but the attention in [33], [32] is about the structured internal memory instead inconsistent with the literature.

Motivated: Different neural transmitters have different effects to different neurons, e.g., resulting in (a) avoiding pains, seeking pleasures and speeding up learning of important events and (b) uncertainty-and novelty-based neuronal connections (synaptic maintenance for auto-wiring) and behaviors (e.g., curiosity).

Abstractive: Each learned concept (e.g., object type) in Z are abstracted from concrete examples in z∈Z and x∈X, invariant to other concepts learned in Z (e.g., location, scale, and orientation). E.g., the type concept “dog” is invariant to “location” on the retina (dogs are dogs regardless where they are). Invariance is different from correlation: dog-type and dog-location are correlated (e.g., dogs are typically on ground).

The GENISAMA control as DN: Assume a human knowledge base is representable by a grand TM, whose FA control has alphabet Σ={σ₁, σ₂, . . . , σₙ}, a set of states Q={q₁, q₂, . . . , gₘ}, and a static lookup table as its transition function δ:Q× [symbol] Q. The lookup table has n columns for n input symbols and m rows for m states. Each transition of the FA control is from state qᵢ and input σⱼ, to the next state qₖ, denoted as (qᵢ, σⱼ)→qₖ, corresponding to the qₖ entry stored at row i and column j, in the lookup table.

Required by GENISAMA, let grounded n (emergent) vectors X={x₁, x₂, . . . , xₙ,} represent the n (static) symbols in Σ, so that xⱼ≡σⱼ, j=1,2, . . . , n where means “corresponds to”. Likewise, let m (emergent) vectors Z={z₁, z₂, . . . , zₙ,} represent the m (static) symbols in Q, so that zᵢ≡qᵢ, i=1,2, . . . , m. m. Thus, each symbolic transition (left, static) in FA corresponds to the vector mapping (right, emergent) in DN:

[(qᵢ, σᵢ)→qₖ]≡[(zᵢ, xⱼ)→zₖ].

Because of the reasons in Weng [128], the lookup table for the human common-sense base is exponentially wide and exponentially high, but also extremely sparse. Yet, the right-side in the above equation uses only observed sparse entries emerged, where each entry corresponds to a neuron in DN.

Denote \dot{v}=v/∥v∥, i.e., normalizing the Euclidean length of v.

The neurons in X and Z are open to the environment, supervisable by the environment.

Next, let the Grand TM in the environment teach the DN by supervising its X and Z ports while TM runs, one transition at a time in real time. The DN has its brain area Y area hidden (i.e., skulled).

The simplest DN learns incrementally as follows. Given each observation (z, x) from the teacher TM, all Y neurons compute their goodness of match. Each Y neuron (i, j) corresponds to an observed transition at the (i, j) entry of the lookup table. In order to match both z and x, it has a two-part weights vᵢⱼ=(tᵢⱼ, bᵢⱼ) When the best match is not perfect explained below, (z, x) is the left-side of a new transition; so DN incrementally adds one more Y neuron by setting its tᵢⱼ=zᵢ and bᵢ=xⱼ. So, DN adds up to (finite) inn hidden neurons, but typically much fewer because the lookup table is sparse.

The top-down match value is νₜ=\dot{t}·ż; and bottom-up match ν_{b}=\dot{b}·\dot{x}. We know that \dot{a}·\dot{b}=cos θ, where θ is the angle between the two unit vectors \dot{a} and \dot{b}cos θ=1 is maximized if and only iff \dot{a}=\dot{b}, namely θ=0. The match between the current context input (z, x) with the weight (t, b) of a Y neuron is the sum (or product) of the bottom-up and top-down match values, as its pre-response value:

f(z,x|t, b)=νₜ+ν_{b}=\dot{t}·ż+\dot{b}·\dot{x}

Only the best matched Y neuron fires (with response value 1), determined by a highly nonlinear competition:

$$( {i}^{′} , {j}^{′} ) = arg {max}_{( i , j ) ∈ Y} f ( z , x \vert {t}_{ij} , {b}_{ij} ) = arg {max}_{( i , j ) ∈ Y} \{ {\dot{t}}_{ij} \cdot \dot{z} + {\dot{b}}_{ij} \cdot \dot{x} \} .$$

All other loser Y neurons do not fire (response value 0), because otherwise these neurons not only create more noise but also lose their own long-term memory (since all firing neurons must update using input).

The area Z incrementally updates so that the firing Y neuron (i′, j′) is linked to all firing components (i.e., 1 not 0) in zₖ, so DN accomplishes every observed transition (zᵢ₁, xⱼ)→zₖ, error-free, as proved in Weng [131].

Using the optimal Hebbian learning in Methods, Weng [131] further proved that (1) the weight vector of each Y neuron in the optimal (maximum likelihood) estimate of observed samples in (X, Z), (2) the weight from each Y neuron (i′, j′) to each Z neuron k is the probability for (i′, j′) to fire, conditioned on k fired, and (3) overall, the response vectors y and z are both optimal (maximum likelihood).

Thus, DN uses at most mn Y neurons, observes each symbolic transition (qᵢ, σⱼ)→qₖ in TM represented by vector transition (zᵢ, xⱼ)→zₖ, and learns each error-free if each input (z, x) is noise-free. If input (z, x) is noisy, DN is optimal. Namely, DN both “over fits” and is optimal, regardless input is noisy or noise-free. This is a new proof for TM emerging from DN, shorter but less formal than Weng [131].

Attention corresponds to weights t and b partially connected with Z area and X area, respectively,—thanks to naturally emerging patterns z and x.

Auto-programming: Consider two learning modes. Mode 1: Learn from a teacher TM supervised. Mode 2: Learn from the real physical world without any explicit teacher. For early learning in Mode 1 to be useful for further learning in Mode 2, assume that the patterns in Mode 1 are grounded in (i.e., consistent with) the physical world of Mode 2.

Theorem 2: By learning from any teacher TM (regular or universal) through patterns (Modes 1 and 2) with top-1 firing in Y, the DN control enables a learner GENISAMA TM to emerge inside it with 21 the following properties.

1) Sufficient neurons situation: The GENISAMA TM is error-free for all learned TM transitions (Mode 1) and resubstitution of all observed physical experiences (Mode 2).

2) Insufficient neurons situation: This happens when the finite n Y neurons have all been activated. The action at time t+1 is optimal in the sense of maximum likelihood (but not error-free) in representing the observed context space (z, x), conditioned on the amount of computational resource n and the experience of learning for all discrete times 0, 1, 2, . . . , t.

The proof is available in Methods.

Next, consider auto-programming for general purposes. We represent each purpose as a TM. Suppose a Grand Transition Table G represents the FA control of a grand TM. This G contains a Universal TM Tᵤ and a finite number of tasks as TMs, Tᵢ, i=1, 2, . . . . Traditionally, Tᵤ is based on a (symbolic) computer language, but here Tᵢ, can be in a (non-symbolic) natural language if it is GENISAMA.

Theorem 3: A GENISAMA TM inside DN automatically programs for general purposes Tᵢ, i=1, 2, . . . , after it has learned a Universal TM T ₁ and the related purposes Tᵢ, i=1, 2, . . . . However, the DN algorithm (developmental program) itself is task-independent and language-independent (e.g., English or Chinese).

The proof is available in Methods. Therefore, it has been constructively proved in theory in this report that a machine can perform auto-programming for general purposes. Because of the auto-programming and general purpose, strong AI seems to be possible using the presented theory.

Table I compares TMs, Universal TMs, grounded symbolic machines, prior neural networks, and GENISAMA TMs.

TABLE I
Different Types of Machines

| Machine types | ™ | Universal ™ | Grounded symbolic | Prior neural networks | GENISAMA ™ |
|---|---|---|---|---|---|
| Unknown tasks | No | Yes | No | Pattern recognition only | Yes |
| General purpose | No | Yes | No | No | Yes |
| Grounded | No | No | Yes | Yes (can be) | Yes |
| Auto-program | No | No | No | No | Yes |

### III. Methods

Before we discuss the detail of the new methods, let us first review major methods in the literature.

In Artificial Intelligence, there are two schools, symbolic and connectionist [72], [128], [31]. On one hand, the meanings of symbolic representations (e.g., Bayesian Nets [82], [60], Markov models [88], [86], graphic models by many) are static (before probability measures) in the human designer's mind and design documents, but are not told to the machine. For example, such symbolic representations prevent the machine from learning the meanings of new concepts beyond those having already been statically handcrafted. On the other hand, representations in artificial neural networks can emerge from activities but lack [72], [31] clearly understandable logic, such as abstraction, invariance, and the hierarchy of relationships. For example, deep learning networks [26], [134], [99], [61], [73], [58] and other brain function that appears to be necessary to scale up from a human fetus, to human infant, to human adulthood: a system automatically and directly learns from physical world for open domains.

The work there demonstrate, through a constructive proof, that this requires a framework that is beyond from-pixels-to-handcrafted-text [26], [134], [1], [17], [99], [61], [73], [58], that is not an emergent-and-symbolic-hybrid [1], [73], [58], [109] either, but rather whose representations are exclusively emergent and there are no symbols in DN at all. In such a drastically different architecture and its representations, detection, recognizing, attention, and action on individual object(s) all take place in parallel in cluttered environments where background pixels are often many more than object pixels.

Unique in this regard, representations in DN [126], supported by a series of embodiments called Where-What Networks, WWN-1 through WWN-9, take the best of both AI schools: not only emergent, but also logic; not only logic, but also complete in the sense of TM [131]. However, it is unknown whether a DN can auto-program for general purposes. The work here takes up this fundamental issue: Can machines automatically learn to think for general purposes—not relying on any handcrafted symbols, let alone any world models?

In Natural Intelligence, the task-nonspecificity of an innate Developmental Program (DP) is highly debatable [9], [19], [18], [87], [4], [84], [137]. It is still unclear computationally how a DP can regulates a neural network, natural or artificial, to enable the network to auto-program concepts and rules from the cluttered physical environment. This report proposes a computational theory for that without claiming to be biologically complete. Since spontaneous neuronal activities are present prenatally [56], [23], the activity-dependent wiring mechanisms here could take place both before and after birth. The model proposed here contains supports for both nativism and empiricism, but more explicit and precise computationally.

Theories of machine-learning logical computations have been fruitfully studied (e.g., [118], [119], [50]) to deal with propositions and predicates, whose answers are, yes or no (e.g., fraud or not fraud), but not both. The full automation of machine learning in the real world—e.g., the emergence of representations (i.e., skull closed, through lifetime learning of an open series of unpredictable tasks) and automatic scaffolding (i.e., early-learned simple skills automatically assist later learning of more complex skills)—has not received sufficient attention. However, this is the way for brains to autonomously learn from infancy to adulthood. Since the Autonomous Mental Development (AMD) direction was proposed in [137], a major progress in this direction, represented by the Where-What Networks [126] as embodiments of DN, has not received sufficient attention either (see, e.g., recent reviews [61], [99], [50]). However, the full automation of machine learning seems to be a practical way for machines to become as versatile as a 3-year-old human child in the three well acknowledged bottleneck areas of AI—vision, audition and natural language understanding. The theory here is necessary for the full automation of machine learning.

Through Finite Automata [41], [68], we extend such logic to spatiotemporal sensorimotor actions, to deal with kinds of intelligence that require behaviors, including vision, audition (recognition of not only speech, but also music, etc.), natural language acquisition, and vision-guided navigation. Namely, not only logic, but also interactive actions where logic is a special case.

There are two types of approaches to modeling a brain. The first type assumes that the genome rigidly dictates all Brodmann areas (e.g., V1 and V2) inside the brain so such a model starts with static existence of the Brodmann areas such as those reported by [22]. The second type, which this model belongs to, does not assume so. Such a model does not have static brain areas because the formation of, and the existence of, brain areas depend on activities, as demonstrated by the following studies:

1) Cells in the V1 area selectively respond to the left eye, the right eye, and both eyes in a normal kitten; but they respond only to one eye if the other eye is closed from birth [138]. Namely, where an area connects from is plastic.

2) A pathway amputation early in life enabled the auditory cortex to receive visual signals through actively growing neurons so that the auditory cortex emerged visual representations and the animal demonstrated visual capabilities using rewired auditory cortex [120]. Namely, what an area does is plastic.

3) The visual cortex is reassigned to audition and touch in the born blind [121]. Namely, visual areas may completely disappear.

Therefore, the DP of this model does not specify Brodmann areas. It enables “general purpose” neurons to wire, trim, and re-wire. But the experimental demonstration for the formation of the spinal cord and the detailed Brodmann areas in the DN, as well as the plasticity thereof, remains to be future work.

The following questions are: Is there a central controller in the brain? Is there a Master Map in the brain? Does the genome rigidly specify features or instead features emerge from both prenatal (i.e., innate) and postnatal development? Does the brain uses convolution—replication of neural weights across different neurons? Does the brain consist of a rigid deep cascade of processing modules? Inspired by the above plasticity studies, the new theory here does not assume the static existence of a Master Map proposed by Anne Treisman 1980 [113], [114] and used by others [2], [79], [116], [45]. Such a Master Map requires a central controller who is already intelligent, so that it selects every attended object image-patch from each figure-ground-mixed image on the retina and feeds only attended figure patch into the Master Map. In the Master Map, the location and scale of the figure are normalized so that remaining issue is only classification. In some sense, the “normalization” that we hope is performed by the motoric area Z in the theory area, but Z is not a feature map but an action map.

In the Computational Vision literature, such a central controller is a human. Bottom-up features [63], [135] and their saliencies have been proposed [79], [45], [44] to partially serve the role of this central controller—a salient patch is fed into the Master Map. Another example of human central controller is Cresceptron [132], [134] and much later work where the human trainer manually draws a polygon on the sensed image that segments a human attended figure from the ground so that the system learns bottom-up from only pixels inside the polygon. However, the brain anatomy [22], [54] appears to allude to us that the brain network contains various shallow and deep circuits in which bi-directional connections are almost everywhere, not just a cascade. The new theory here assumes that neurons automatically connect, not only bottom-up, but also top-down [65], [7], [89], [95], [67], [136] and lateral, all using accumulated statistics in neuronal activities.

Deep learning convolutional networks [28] with max-pooling [134], [102] and other techniques [62], [59], [98], [61], [73], [99], [50] have shown their power in pattern classification—output class labels. They all imposed a cascade of processing modules/layers. The max-pooling is meant to reduce the location resolution from each early layer to the next layer to avoid the exponential explosion of the template size of convolution. However, the amount of computation can be contained by enabling each Y feature neuron—in early and later layers—to have two input sources, bottom-up from X and top-down from Z. Therefore, not only location “resolution” is automatically reduced from early to later Y areas through the ventral pathway (for outputting class information), but also the type “resolution” is also automatically reduced from early to later Y areas through the dorsal pathway (for outputting location-and manipulation-information). This top-down and bottom-up two-input (z, x) architecture seems to provide a more flexible architecture for dealing with pattern recognition, either from monolithic or from cluttered scenes. Such a non-cascade network seems to be consistent with neuroanatomical studies reviewed in [22].

Agent FA To understand how a symbolic state can abstract both spatial and temporal contexts, consider Task 1: Produce the truth-value of an input logic-AND expression like:

T∧F∧T∧T

written on a tape. A regular FA only has an input string not a tape but this tape-view is useful next. We allow the tape head to read the input sequence by moving only right, a symbol at a time, and to

TABLE II
Control δ of FA for Task 1 and the pattern representations
of state q and input σ

| | | Input σ | | |
|---|---|---|---|---|
| | | Input pattern x | | |
| δ(q,σ) | | T | F | ∧ |
| State q | State pattern z | 010 | 011 | 100 |
| q₀ | 001 | q_{T} | q_{F} | q₋ |
| q_{T} | 010 | q₋ | q₋ | q_{T∧} |
| q_{F} | 011 | q₋ | q₋ | q_{F∧} |
| q_{T∧} | 100 | q_{T} | q_{F} | q₋ |
| q_{F∧} | 101 | q_{F} | q_{F} | q₋ |
| q₋ | 110 | q₋ | q₋ | q₋ |

read only. In general, such a logic-AND expression consists of a finite number of input symbols from alphabet Σ={T, F, ∧}, where T and F represent true and false, respectively, and ∧ denotes logic AND. Let Q be the set of states of the FA handcrafted by a human programmer.

The control of an Agent FA is a function δ: Q×Σ [symbol] Q, a mapping from domain Q×Σ to codomain Q.

Table II gives the control for Task 1, where the meaning of each state is denoted by the subscript of q. The patterns for x and z will be needed later in the paper. At row q and column σ is the next state q′=δ(q, σ), or denoted graphically as (q, σ)→q′. E.g., at the initial state g₀, receiving an input T, the next state is q_{T} to memorize the context T. This gives δ(q₀, T)=q_{T}. Similarly, δ(q_{T}, ∧)=q_{T∧} to memorize context T∧. Then, q′=δ(q_{T∧}, F)=q_{F}, because T∧F=F. The transition sequence for the above input T∧F∧T∧T is

$${q}_{0} {\to }^{ T } {q}_{T} \hat{\to } {q}_{T} {\to }^{ F } {q}_{F} \hat{\to } {q}_{F} {\to }^{ T } {q}_{F} \hat{\to } {q}_{F} {\to }^{ T } {q}_{F} . \qquad ( 1 )$$

The state q_ represents that the input sequence is an invalid logic-AND expression, e.g., ∧TF or F∧∧.

This is temporal abstraction from examples: Each state memorizes only the necessary context information for the specific Task 1. The abstraction in the previous state facilitates the abstraction of the next state. In natural language acquisition, the temporal context for each state is similar but more complex.

As spatial abstraction from examples, we can extend the Task 1 so as to handle symbol T as T and ϕ as F, respectively. All we need to do is expand Table II by adding two additional columns for inputs τ and ϕ, respectively, but using the same next states as T and F. During vision-guided autonomous driving, different traffic semaphores are like T and τ here, but more complicated.

Thus, both spatial and temporal abstractions take place concurrently in each transition: (q, σ)→q′. We will see in Table V below that when a brain applies this mechanism to patterns, the brain deals with space and time in a unified way, independent of meanings.

It is useful below to see how the control implements Table II: Given any state q and input σ, the control finds the matched row q at row and matched column σ. The table cell stores the information for the next state q′. Below, each table cell will correspond to a neuron whose inputs are the original patterns (not symbols) of q and σ as shown in Table II.

In Task 1, inputs T and T∧T lead to the same state q_{T}. This process requires state design and equivalent-state finding for spatiotemporal abstraction. Handcrafted by humans, such symbolic representations are logic and clean [72], [31]. But they become manually intractable and thus error-prone (brittle) when the transition table has exponentially many rows and columns for natural languages or autonomous driving [64], [97], [128], [37], [142]. Below, we will see that the natural world can supervise each transition (q, σ)→q′ but using directly patterns which are without human handcrafting.

Attentive Agent FA An Attentive Agent FA has a set of input symbols, called alphabet Σ, of a finite size. At each time t, t=1, 2, . . . , it attends to a set Σ(t)⊂Σ of symbols from the symbolic environment E(t) [85], [57], [16], [11], [46], [49], [67]. The set Σ(t) can be a 2-D patch of text (e.g., of this page) or a substring of the input sequence (e.g., T∧F of T∧T∧F∧T). The state/action from the machine may change the environment and also the next sensed Σ(t+1).

In Task 1, the single-letter right-only scan is only one of many ways of the Attentive Agent FA. For an unconstrained Attentive Agent FA, a human programmer must handcraft a large lookup table δ: Q×2^{Σ} [symbol] Q so that the output state q(t)∈Q at every time t enables the Attentive Agent FA to sequentially complete the given task. The number of columns of the transition table of δ is exponential in the size of Σ because of the power set 2^{Σ} in the domain of δ. The number of rows, the size of Q, may potentially also be exponential in the size of Σ.

Task 1 does not need this freedom of attention. However, an Attentive Agent FA is useful for the more challenging Task 2: Produce the truth value of an input sequence that includes logic operators ∧, ∨, and parentheses, such as:

T∧((T∨F)∧T∨F).

It is known [41], [68] that the single-letter right-only scan can still accomplish Task 2 if the machine has an infinite-size stack so that it can store an unbounded number of left parentheses.

If the machine can write onto the tape, the machine is a TM illustrated in FIG. 1A without the need for the stack. A human can program a TM to perform Task 2 [41], [68].

Proof of Theorem 1: The control of a TM has a transition function δ: Q×Γ [symbol] Q×Γ×D, where Q, Γ and D={R, L, S} are the sets of states, the tape alphabet, and head moves, respectively. We extend δ to δ′: Q′×Γ [symbol] Q′ which is the form of the control of an Agent FA, where Q′Q=×Γ×D. We have proved that the control of a TM is an Agent FA. The above extension of domain from Q×Γ of δ to Q′×Γ of δ′ means that for all q′=(q, γ, d) ∈Q×Γ×D and γ′∈Γ, δ′(q′, γ′)=δ(q, γ′). Namely δ′ is independent of, or does not attend to, the last written symbol γ and head move d in its domain (as they are often encoded in state). But this attention is dynamic, as the head can scan multiple positions to reach a state. Namely, the control is an Attentive Agent FA. This ends the proof.

A Grounded Symbolic Machine illustrated in FIG. 1B can deal with additionally input patterns (image, LIDAR, sound, etc.), but it cannot automatically program for general purposes because it still requires a human programmer to handcraft the meanings of every input symbol a used to represent its input features, internal states q, and output actions. A probability version [93] alleviates the uncertainty in such symbols, but cannot address the inadequacy of static symbols to represent a new town, or a new situation (e.g., rain or hacker laser [38] for LIDAR)

Neural networks (e.g., [92], [71] and many others) have been using patterns directly; but traditional neural networks do not have grounded symbol-like capabilities [36], [72], [11O]. Bridging this gap requires a machine to learn not only symbol-like concepts directly from non-symbols but also attention rules—to quickly capture relevant patches (e.g., s in FIG. 1B) that are necessary for immediate action and disregard remainders (e.g., s̅ in FIG. 1B). Such attention rules are implicit; we often attend without knowing reasons. The intractability of handcrafting such implicit rules demands general-purpose auto-programming.

GENISAMA TM. Early neural network models for FA [24], [25], [81] and for TM [105], [104] are laudable for computing the automata mapping using networks but they used special encodings and do not learn, having none of GENISAMA. E.g., the TM in [105], [104] used 2-D registered inputs (one signal line and the other line means the presence of signal in the signal line). In contrast, the inputs in X here are unregistered (e.g., an object can appear anywhere in the image) and cluttered (typically more noise/background dimensions than signal dimensions). The TM in [104] extends to irrational numbers using infinitely long numbers, but words of a finite length should be sufficient for a practical GENISAMA TM (e.g., it recognizes and understand the irrational number \sqrt{2}by the shape \sqrt{2} and its rules instead of the infinitely long number).

The environment of the control DN is divided into internal environment (e.g., the network that learns an equivalent lookup table for the control but more efficient than exponential) and external environment. The external environment includes the body of the agent and extra-body environment.

Each area of DN control may have multiple subareas: X may contain two retinae, two cochlear hair cell arrays, somatosensory arrays, and receptor arrays of other sensory modalities. Z may contain muscle arrays for the mouth, the arms, and effectors of other motor modalities. Y as the internal representation of the control senses the pattern in its input space Z×X={(z, x)|z∈Z, x∈X} to produce Y patterns. In turn, each of X and Z uses the Y pattern to further predict the pattern in themselves. Motivated by brain plasticity discussed below, we let subareas in Y to automatically emerge (like Brodmann areas [54], [30]) instead of statically handcrafted.

Suppose, in Table III, a GENISAMA TM learns from a teacher TM. The teacher is via its Attentive Agent FA control and the learner is via its DN control. For clarity, suppose that each area of DN finishes an update computation in a unit time. Then, let every area of DN run in discrete times t=0, 1, 2, . . . in parallel. The Attentive Agent FA does not have any internal area because it is symbolic—a lookup table is sufficient. The DN takes an additional unit time for the Y area to update and interpolate. That is why Table III only needs to specify the Attentive Agent FA at even time instants.

TABLE III
The correspondence between the symbolic
Attentive Agent FA and the DN control of GENISAMA TM
$\begin{matrix}[ \begin{matrix}q ( 0 ) \\ σ ( 0 )\end{matrix} ] & \to & \to & \to & [ \begin{matrix}∅ & \overline{q ( 2 )} \\ ∅ & \underline{σ ( 2 )}\end{matrix} ] & \to & \to & \to & [ \begin{matrix}∅ & \overline{q ( 4 )} \\ ∅ & \underline{σ ( 4 )}\end{matrix} ] & \to & … \\ [ \begin{matrix}z ( 0 ) \\ x ( 0 )\end{matrix} ] & \to & y ( 1 ) & \to & [ \begin{matrix}∅ & \overline{{z}^{′} ( 2 )} \\ ∅ & \underline{{x}^{′} ( 2 )}\end{matrix} ] & \to & y ( 3 ) & \to & [ \begin{matrix}∅ & \overline{{z}^{′} ( 4 )} \\ ∅ & \underline{{x}^{′} ( 4 )}\end{matrix} ] & \to & … \\ y ( 0 ) & \to & [ \begin{matrix}∅ & \overline{{z}^{′} ( 1 )} \\ ∅ & \underline{{x}^{′} ( 1 )}\end{matrix} ] & \to & y ( 2 ) & \to & [ \begin{matrix}∅ & \overline{{z}^{′} ( 3 )} \\ ∅ & \underline{{x}^{′} ( 3 )}\end{matrix} ] & \to & y ( 4 ) & \to & …\end{matrix}$

In Table III, the first row is the time flow of the Attentive Agent FA control of the teacher TM where q(t) and Q(t), t=0, 2, 4, . . . , are the attended state/action and input, respectively.

A traditional FA does not predict input at all (see Eq. (1)), but we require an FA or Attentive Agent FA to predict not only the next state q′ but also the next input σ′. New here is that we use q and σ both

to predict also σ′:

$$[ \begin{matrix}q \\ σ\end{matrix} ] \to [ \begin{matrix}{q}^{′} \\ {σ}^{′}\end{matrix} ] . \qquad ( 2 )$$

The more obstructively complete q is, the better the prediction for σ′. When such a prediction of σ′ is not unique, the agent is immature to explain the attended environment. A calf might be mature in terms of finding food, but immature in terms of avoiding its predators.

With the real time indices in Table III, the framework of Bayesian Networks [82], [94] can be applied to the Attentive Agent FA while avoid cyclic graphs in graphical models because each cycle occurs at a different time instance above. This deals with the problem of cyclic graphs that static graphic models have avoided.

In each 2×2 array inside Table III, the first column is predicted by the control and the second has been affected by supervision from the environment. ∅ means an empty set—the prediction is undetermined. An underline for input (e.g., σ(2)) or overline for state/action (e.g., q̅(̅2̅)̅) means the environment supervises and the supervision is different from what the control predicted.

The control DN of GENISAMA TM learns from the teacher TM by taking one taught (q′, σ′) at a time in Eq. (2), but dealing with patterns directly. Symbolically, it learns a mapping δ: Q×Σ [symbol] Q×Σ from the teacher TM (e.g., mother or school instructor).

The DN uses original patterns z(t) and x(t) whose attended parts correspond to symbols q(t) and σ(t), respectively, denoted as α(z(t))≡q(t) and α(x(t))≡σ(t) where function α is a dynamically learned function that marks off the unattended components.

Running at times t=0, 1, 2, 3, 4, . . . , the 2nd and 3rd rows in Table III are two flows that run in parallel to predict the corresponding patterns x, y, z in all the three areas of the DN. The Y area takes input from (z, x) to produce a response vector y which is then used by Z and X areas to predict z and x respectively:

$$[ \begin{matrix}z \\ x\end{matrix} ] \to y \to [ \begin{matrix}{z}^{′} \\ {x}^{′}\end{matrix} ] \qquad ( 3 )$$

where the first → denotes the update in the left side using the left side as input. Like the FA, each prediction in Eq. (3) is called a transition. The same principle is also used to predict the binary (or real-valued) x′∈X in Eq. (3). The quality of prediction depends on how state/action z abstracts the external world sensed by x′.

Learning As the simplest version, we use a highly recurrent, winner-take-all computation to simulate parallel lateral inhibition in Y: the Y area with n neurons responds with y=(y₁, y₂, . . . yₙ) where

$${y}_{j} = \{ \begin{matrix}1 & if j = {argmax}_{1 \leq i \leq n} \{ {f}_{i} ( z , x ) \} \\ 0 & otherwise\end{matrix} \qquad ( 4 )$$

j=1, 2, . . . n, where each fᵢ measures the goodness of match between its input patch in (z, x) and its weight vector (zᵢ, xᵢ). The Hebbian learning together with the synaptic maintenance explained below initialize, update, cut-and-grow, all weight vectors (zᵢ, xᵢ), i=1, 2, . . . , n, resulting the rich connections illustrated in FIG. 2A-2B.

Let the FA control of the teacher TM have r rows and c columns. Suppose that in the learner GENISAMA TM, the Y area has at least n=rc Y neurons. For Table II, n=rc=6×3=18. Without any central controller, all Y neurons start with random weights at time t=0. At each time t, t=1, 2, . . . , only the winner Y neuron fires at response value 1 and incrementally updates its weight vector (zᵢ, xᵢ) as the vector average of attended part of (z, x). Then, the i-th Y neuron memorizes perfectly the i-th distinct input pair (z,x) observed in life.

The learner GENISAMA TM is taught by the teacher TM through the supervision of (z, x). Each Z neuron represents a unique component in z. It should fire at 1 (instead of not firing at 0) if and only if it has been taught to fire right after the firing Y neuron. This is true regardless in how many Z patterns this Z neuron appears. In general, if the number of Y neurons is insufficient and input in (z, x) has noise, the weight from the firing Y neuron to each Z neuron is the incrementally updated probability for the pre-synaptic Y neuron to fire conditioned on that the post-synaptic Z neuron fires.

Therefore, the roles of working memory and long-term memory in each area Y are dynamic—the firing neurons are the current working memory and all other currently non-firing neurons are the current long-term memory. In this way, it is always the best matched neurons to update while other non-firing neurons keep their memory intact. When the number of Y neurons is large, the finite-size DN appears to never run out of memory because the top-matched neurons are near and the forgetting/update is for the nearest memory only.

Top-k and brain areas In general, top-k (k>1) neurons fire, as members of a distributed Y “committee” in which only k experts fire to vote, as illustrated in FIG. 2B. The top-k mechanism itself is not biologically plausible, but it simulates mutual inhibitions among neurons (see FIG. 2A) so that much fewer Y neurons fire in the presence of mutual inhibitions (see sparse coding idea [80]).

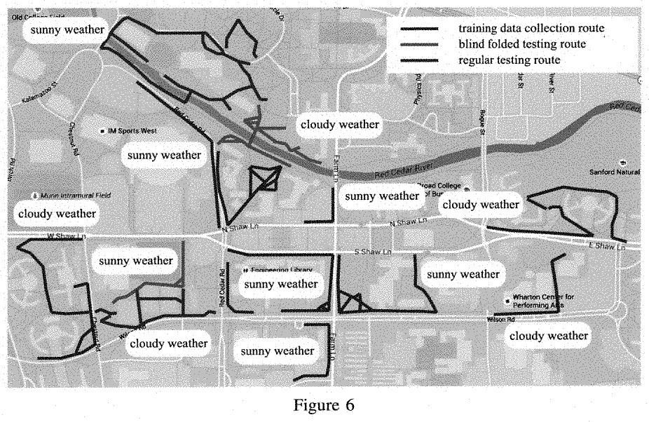

The top-k voting in Eq. (3) was called the “bridged-islands” model [130]. In general, the “bridge” Y area can be considered any brain area where neurons fire to be used by its connected islands—top islands Z and bottom islands X. The complex brain network hierarchy (e.g., see [22]) is not a cascade as modeled in deep learning. Each area is a bridge that provides feature detectors for all neurons that are statistically correlated through excitatory connections and anti-correlated through inhibitory connections (see [127]). Consequently, the sensory end of DN is the most concrete, having 100% sensory content and 0% motoric content. The motor end of DN is the most abstract, 0% sensory and 100% motoric. Other areas in DN are in-between, developing intermediate abstract features that correspond to intermediate invariances (see, e.g., FIGS. 6.5 and 6.6 in [127]). This avoids the forced feedback loop in electrical engineering—from the most abstract Z back to the most concrete X (see, e.g., [73]).

Dynamic learning modes The open ports Z and X are supervised or free, depending on the external and internal environments. By “supervised”, we mean that, as soon as the port predicts a pattern as the left-column in each 2×2 array in Table III, the external world overrides it as the right column of the 2×2 array. Otherwise, the Z port is “free”, predicting/generating actions from within. If the “eye” is closed, the X port is not supervised by the external environment and the X port predicts “mental images”. (But “mental images” can, in principle, emerge also from early subareas in Y like LGN, V1 etc. or written on a piece of paper through actions in Z, not requiring the eyes to close.)

Never directly supervised, the closed Y uses unsupervised learning—optimal Hebbian learning explained below, although the agent's action maybe supervised by a teacher through the Z area. Namely, the body of the agent always supervises DN, but the Y area always uses unsupervised learning!

Let us look at the example in Eq. (1). We must let q and σ predict in parallel:

$$\begin{matrix}[ \begin{matrix}{q}_{0} \\ \underline{T}\end{matrix} ] \to [ \begin{matrix}∅ & \overline{{q}_{T}} \\ ∅ & \underline{}\end{matrix} ] \to [ \begin{matrix}∅ & \overline{{q}_{T}} \\ ∅ & \underline{F}\end{matrix} ] \to [ \begin{matrix}∅ & \overline{{q}_{F}} \\ ∅ & \underline{}\end{matrix} ] \to [ \begin{matrix}∅ & \overline{{q}_{F}} \\ ∅ & \underline{T}\end{matrix} ] \\ \to [ \begin{matrix}∅ & \overline{{q}_{F}} \\ ∅ & \underline{}\end{matrix} ] \to [ \begin{matrix}{q}_{F} & {q}_{F} \\ T & T\end{matrix} ] \to [ \begin{matrix}{q}_{F} \\ \end{matrix} ] .\end{matrix} \qquad ( 5 )$$

where the last two predictions are perfect because of two reasons: (a) the two predictions of state are unique due to the teacher consistency; (b) the two predictions of input are unique since the learner is still naive—only T follows (q_{F}, ∧) and it has not seen illegal input. (Without better states that model the physical causality of input sequence, such symbolic prediction of input is not guaranteed to be unique.)

Using the patterns in Table II, which are meaningless here but should correspond to naturally emerging images, the DN learns the above teacher sequence one transition at a time, but through original patterns only and via Y neurons:

$$\begin{matrix}[ \begin{matrix}001 \\ \underline{010}\end{matrix} ] \to {y}_{1} \to [ \begin{matrix}∅ & \overline{010} \\ ∅ & \underline{100}\end{matrix} ] \to {y}_{2} \to [ \begin{matrix}∅ & \overline{100} \\ ∅ & \underline{011}\end{matrix} ] \to {y}_{3} \to [ \begin{matrix}∅ & \overline{011} \\ ∅ & \underline{100}\end{matrix} ] \\ \to {y}_{4} \to [ \begin{matrix}∅ & \overline{101} \\ ∅ & \underline{010}\end{matrix} ] \to {y}_{5} \to [ \begin{matrix}∅ & \overline{011} \\ ∅ & \underline{100}\end{matrix} ] \to {y}_{4} \to [ \begin{matrix}101 & 101 \\ 010 & 010\end{matrix} ] \\ \to {y}_{5} \to [ \begin{matrix}011 \\ 100\end{matrix} ]\end{matrix} \qquad ( 6 )$$

where yᵢ, i=1, 2, . . . , 5, corresponds to the first five initialized Y neurons. Two Y neurons y₄ and y₅ predict perfectly when the same (or similar) pattern of (q, σ) appears again. The term “similar” means interpolation that is impossible in Eq. (5).

Attention For simplicity, we have assumed above that z and x do not contain unattended parts. Of course, in general the prediction of x pattern can cover fewer than all sensory bits (3 bits above), amounting to experienced-based global-or-local sensory attention—predicted bits are attended. Namely, how the learner machine attended in the past “lifetime” shapes how it likely attends in the future “lifetime”.

This example shows the model's separation of DP mechanisms (i.e., table lookup) from the meanings of the learned task. Namely, the human programmer of the DP does not need to know the meanings of patterns in Eq. (6) that emerge. A regular TM and a Universal TM differ in the meanings of input symbols and state symbols, but they use the same domain Q′×Σ and codomain Q′ (i.e., table lookup) for their control function δ′. Therefore, the table lookup mechanism for Eq. (6) is sufficient for not only a regular TM but also a Grand TM that contains many TMs and some Universal TMs.

Scaffolding Scaffolding means simple skills learned early assist the learning of complex skills later [122], [139]. Imagine that while the automaton grows from “embryo” to “adult”, such meanings become increasingly sophisticated and are internalized as clusters in the later Y areas (see FIG. 2A-2B). These state/action patterns may also be of any complex meanings, e.g., “goals” and “intents” [136] that are taught/learned in the “language” of actions. In rats goals have been found in the pre-frontal cortex [42]. Such meanings may entail creativities, as self-generated programs through predictions like those in Eq. (6). Off-task processes [106] (i.e., the automaton takes a short break from task execution to “think”) allow generalizations/creativities, through the seemingly-rigid pattern prediction in Eq. (6).

Computational complexity Assume that the dimension (e.g., number of pixels) of X is α. Each component of X has 10 possible (e.g., color) values. Then, there are c=10^{α} possible X patterns.

Let the Z area has β concept zones (4 in FIG. 2A-2B), where each zone has 10 concept values. There are r=10^{β} possible Z patterns.

Then, there are rc=10^{α}10^{β}=10^{α+β}possible patterns in (z, x), exponential in α and β. For example, when α=640×480 (pixels) and β=4 (zones), the transition table for FA already requires 10¹²²⁸⁸⁰⁰ entries, 10¹²²⁸⁷⁸⁹ times more than the number of neurons in a human brain! Note, the table is sparse as many entries are not observed but could appear in “life”.

In contrast, the control DN uses a large (e.g., n=10¹¹ for a human brain) but constant number n of Y neurons to interpolate among observed patterns for dealing with exponentially many rc=10^{α+β} patterns. It may use nβ bottom-up weights of Z to interpolate among observed Y patterns for exponentially many possible Z patterns. Similarly, it uses nα top-down weights of X to interpolate among observed Y patterns for exponentially many possible X patterns.

Namely, the update for each DN takes a (large) constant amount of time, so DN has a linear time complexity O(nt) in t while running in real time t and n is a large constant.

The GENISAMA TM uses a constant resource to optimally (maximum likelihood) interpolate a potentially exponential and unbounded number of observed patterns of (z, x), conditioned on k in top-k competition, the network size, and training [131]. For this highly nonlinear optimization problem, local minima may take place in the given k value, the given network size (larger is always better as over-fitting is not a problem with the nearest neighbor matching), and the given teaching experience (e.g., teaching complex ideas earlier instead of simple ones earlier).

This is not a solution to the P=NP? problem [41], [68]. But it suggests that if each NP problem is investigated in terms of original patterns, not symbolic, (e.g., Euclidean space [3] as X and learned skills as Z), fast and approximate solutions to some NP problems might be available.

Proof for Theorem 2: The two properties 1) through 2) have been constructively proved as Theorems 1 through 3 in [131] for the DN to learn from any FA. But here the teacher is a TM whose control is an Attentive Agent FA according to Theorem 1. We fill this gap. From the condition that the patterns from the teacher TM are grounded, the supervision from the teacher TM are the attended pattern patches. All the new proof needs to do is to replace, everywhere, the attended patch for the monolithic vectors (z, x) in the original proofs of [131] (whose main ideas are explained above). From Theorems 1 through 3 in [131], the DN learns the pattern-version of the TM transition table with the above properties. This ends the proof.

Proof for Theorem 3: According to [41], [68], a universal TM Tᵤ corresponds to a subset of transitions in G. It enables the machine to read some Tᵢ and apply the Tᵢ on data in the environment (i.e., tape for TM but the real-world for GENISAMA TM). Tᵤ treats some information in the environment as rules and others as data. However, the mechanism of G table lookup is independent with, and sufficient for, any Tᵢ's and Tᵤ in C, as well as sharing skills across Tᵢ's and Tᵤ within the G. Auto-programming for general purposes then corresponds to learning and executing the G, here “programming” because of Tᵢ's, “general-purpose” because of Tᵤ, and “auto” because of sharing transitions among Tᵢ's and Tᵤ. (See Table IV for a sharing example where any of the two sub-machines can be replaced by a Tᵤ.) This ends the proof.

Unlike a traditional TM, Theorem 3 allows any practical language of representation, computer languages or natural languages. In Eq. (5), symbols have a static representation, e.g., q_{T∧} means T state followed by ∧. However in Eq. (6), such symbolic meanings are all hidden in patterns. Namely, the meanings of patterns, coded by a language, are in the eyes of the physical world, including teachers. But the human programmer of the DP does not need to know about such languages or tasks, as shown in FIG. 1C.

We can see that the major enabling technology here is a successful, complete, and provable decoupling between computing and rich meanings of computing. Therefore, the algorithm below of DN (i.e., computing) is capable of doing automatic programming for any practically meanings. This report does not deal with meanings of computing but the companion report does.

Next, let us discuss the Developmental Network (DN) for the controller of the GENISAMA TM:

Algorithm of DN: Input areas: X and Z. Output areas: X and Z. The dimension and representation of X and Z areas are determined by the sensors and effectors of the species (or from evolution in biology). They should also be plastic during prenatal development but for simplicity we assume that they are fixed. Y is skull-closed (inside the brain), not directly accessible by the outside.

1) At time t=0, for each area A in {X, Y, Z} (i.e., A=X, A=Y and A=Z) initialize its adaptive part N=(V, G) and the response vector r, where V contains all the synaptic weight vectors and G stores all the neuronal ages. For example, use the generative DN method discussed below.

2) At time t=1, 2, . . . , for each A in {X, Y, Z} repeat:
a) Every area A performs mitosis-equivalent if it is needed, using its bottom-up input b, lateral input r, and top-down input t, respectively. The order from bottom to top is X, Y, and Z. X does not have bottom-up input. Z does not have top-down input. X does not link with Z directly. The lateral input r for each neuron includes responses from other neurons in the same area only.
b) Every area A computes using a globally uniform form of area function f, described below,

(r′, N′)=f(t, r, b, N)

where t is the top-down input (not present for the Z area); b the bottom-up input (not present for the X area); r and r′ are area A's old and new response vectors, respectively; and N and N′ are the adaptive parts of area A, before and after the area update, respectively. To avoid iterations, lateral inhibitions that use A to A connection are modeled by top-k competition in Hebbian-like learning below.
c) As asynchronous computation, every area A in {X, Y, Z} replaces: N←N′ and r←r′.

The DN Algorithm above must update at least twice for the effects of each new signal pattern in X and Z, respectively, to go through one update in Y and then one update in Z to appear in X and Z.

If X is a sensory area, x∈X is always supervised. The z∈Z is supervised only when the teacher chooses to. Otherwise, z gives (predicts) motor output.

The area function f is based on the theory of Lobe Component Analysis (LCA) [135], a model for self-organization by a neural area.

Each area neuron with weight v=(vₜ, v_{b}) (both only when exists) in area A has an input vector p=(t, b) properly trimmed and weighted by synaptic maintenance discussed below. Its pre-response vector is the sum (or product):

r(t, b|vₜ,v_{b})=νₜ+ν_{b}=\dot{v}ₜ·\dot{t}+\dot{v}_{b}·\dot{b} (7)

which measures the degree of match between the directions of v and p, both normalized. Area X does not have bottom-up part and area Z does not have the top-down part.

To simulate lateral inhibitions (winner-take-all) within each area A, only top k winners among the n competing neurons fire. Considering k=1, the winner neuron j is identified by:

$$j = {argmax}_{1 \leq i \leq n} \{ {\dot{v}}_{i} \cdot \dot{p} \} . \qquad ( 8 )$$

Only the single winner fires with response value=1 and all other neurons in A do not fire. The response value r′ⱼ approximates the probability for \dot{p} to fall into the Voronoi region of its \dot{v}ⱼ where the “nearness” is \dot{v}ⱼ·\dot{p}.

All the connections in a DN are learned incrementally based on Hebbian learning [53], [5]—cofiring of the pre-synaptic activity \dot{p} and the post-synaptic activity r′ of the firing neuron. If the pre-synaptic end and the post-synaptic end fire together, the synaptic vector of the neuron has a synapse gain r′\dot{p}. Other non-firing neurons do not modify their memory. When a neuron j fires, its firing age is incremented nⱼ←nⱼ+1 and then its synapse vector is updated by a Hebbian-like mechanism:

vⱼ←w₁(nⱼ)vⱼ+w₂(nⱼ)r′_{j\dot{p}tm (}9)

where w₂(nⱼ) is the learning rate depending on the firing age (counts) nⱼ of the neuron j and w₁(nⱼ) is the retention rate with wᵢ₁(nⱼ)+w₂(nⱼ)≡1. Note that a component in the gain vector r′ⱼ\dot{p} is zero if the corresponding component in \dot{p} is zero.

The simplest version for w₂(nⱼ) is w₂(nⱼ)=1/nⱼ. If the neuron j fires at time tᵢ, r′ⱼ=1:

$${v}_{j}^{( i )} = \frac{i - 1}{i} {v}_{j}^{( i - 1 )} + \frac{1}{i} 1 \dot{p} ( {t}_{i} ) , i = 1 , 2 , … , {n}_{j} , \qquad ( 10 )$$

where tᵢ is the firing time (not the real time t=1, 2, 3, . . . ) of the post-synaptic neuron j. Gene expressions appear to be involved at different times of memory formation [8]. The above is the recursive way of computing the equally weighted batch average of experience \dot{p}(tᵢ):

$${v}_{j}^{( {n}_{j} )} = \frac{1}{{n}_{j}} {\sum }_{i = 1}^{{n}_{j}} \dot{p} ( {t}_{i} ) \qquad ( 11 )$$

In a motivated system, aversive stimuli (e.g., pain) and appetitive stimuli (e.g., pleasure) increase the learning rate, which corresponds to increasing the relative weight for \dot{p}(tᵢ) in Eq.(11) for the Y area so that the experience is better memorized. However, their effects on actions in the Z area are different: the former and the later inhibits and excites, respectively, the pre-response values of the corresponding firing neurons in Z.

The initial condition is as follows. The smallest nⱼ in Eq. (9) is 1 since nⱼ=0 after initialization. When nⱼ=1, the initial value of vⱼ on the right side of Eq. (9) is used for pre-response competition to find this winner j but the initial value of vⱼ does not affect the first-time updated vⱼ on the left side since w₁(1)=1−1=0.

In other words, any initialization of weight vectors will only determine who win (i.e., which newly born neurons take the current role) but the initialization will not affect the distribution of weights at all. In this sense, all random initializations of synaptic weights will work equally well—all resulting in weight distributions that are computationally equivalent. Biologically, we do not care which neurons (in a small 3-D neighborhood) take the specific roles, as long as the distribution of the synaptic weights of these neurons lead to the same computational effect.

If DN learns an Attentive Agent FA as the control of any TM in which each symbol in Q and Γ is represented by a unique natural pattern, the simplest top-1 firing rule is sufficient to be error-free because the number of sample patterns from the TM is finite. If DN learns as the control of a GENISAMA TM in the real world, the number of samples is infinite. Then, the limited number of neurons in the control become an optimal representation of the observed probability distribution in the input-state/action space and the top-k, k>1, firing neurons serve as voting of a committee with dynamically changing k-member, where the composition of the committee is the top-k best-fit experts. The number k should be a dynamic number but when fixed it is a conditional parameter of the optimality.

The “in-place” Hebbian learning biologically observed [52], [74], [5], [13] allows each neuron to learn in its own place using its pre-synaptic and post-synaptic activities. It does not require a central controller that is “aware” of how to replicate weights across corresponding neurons. Convolution is more restricted than the in-place Hebbian learning DN uses here because pattern shifts in convolution only deal with location invariance but not other invariance (e.g., type invariance in location output). The max-pooling technique originally designed for convolution for reducing spatial resolution [132] lead to gaps of “blind” locations as shown in [134]. The in-place Hebbian learning here dynamically tolerates shape distortion by taking inputs from not only X but also early and later Y neurons. Early Y neurons detect smaller object patches (e.g., head, torso, and limbs for human body detection in this neuron); later neurons detect action features that consist of multiple muscle neurons (e.g., action bundles, like syllables in vocal pronunciation). Only statistically highly correlated Y neurons will fire and be linked with this neuron because of the synaptic maintenance explained below.

All the Z neurons may be supervised to fire according to the binary code of Z(tᵢ). Consider a Z subarea, where each subarea represents a concept (e.g., where, what, or scale) in which only one neuron fires to represent the i-th value of the concept. For simplicity, consider top-1 firing in the Y area. Because there is only one Y neuron firing with value 1 at any time and all other Y neurons respond with value 0, the input to Z is \dot{p}=\dot{y}=y. We can see that the Z neuron i has weight vector v=(ν₁, ν₂, . . . , ν_{c}) in which νⱼ is the accumulated frequency fⱼ/αᵢ for Y neuron j to fire right before the Z neuron i fires, fⱼ is the number of firings of Y neuron j, and αᵢ is the firing age of Z neuron i:

$$v = ( \frac{{f}_{1}}{{a}_{i}} , \frac{{f}_{2}}{{a}_{i}} , … , \frac{{f}_{c}}{{a}_{i}} ) , with \frac{{f}_{1}}{{a}_{i}} + \frac{{f}_{2}}{{a}_{i}} + … + \frac{{f}_{c}}{{a}_{i}} = 1 .$$

Therefore, as long as the pre-action value of a Z neuron is positive, the Z neuron fires with value 1.

TABLE IV
Grand Transition Table for Tasks 1 and 3

| | | Input σ | | | | |
|---|---|---|---|---|---|---|
| δ(q , σ) | | s₁ | s₃ | T | F | ∧ |
| State | State | Input pattern x | | | | |
| (q′, q″) = q | pattern z | 101 | 111 | 010 | 011 | 100 |
| (q₁, q₀) | 01001 | (q₁, q₀) | (q₃, qₑ) | (q₁, q_{T}) | (q₁, q_{F}) | (q₁, q_) |
| (q₁, q_{T}) | 01010 | (q₁, q_{T}) | (q₃, qₑ) | (q₁, q_) | (q₁, q_) | (q₁, q_{T∧}) |
| (q₁, q_{F}) | 01011 | (q₁, q_{F}) | (q₃, qₑ) | (q₁, q_) | (q₁, q_) | (q₁, q_{F∧}) |
| (q₁, q_{T∧}) | 01100 | (q₁, q_{T∧}) | (q₃, qₑ) | (q₁, q_{T}) | (q₁, q_{F}) | (q₁, q_) |
| (qₗ, q_{F∧}) | 01101 | (qₗ, q_{F∧}) | (q₃, qₑ) | (q₁, q_{F}) | (q₁, q_{F}) | (q₁, q_) |
| (q₁, q_) | 01110 | (q₁, q_) | (q₃, qₑ) | (q₁, q_) | (q₁, q_) | (q₁, q_) |
| (q₃, qₑ) | 11000 | (q₁, q₀) | (q₃, qₑ) | (q₃, qₒ) | (q₃, qₒ) | (q₃, qₒ) |
| (q₃, qₒ) | 11001 | (q₁, q₀) | (q₃, qₒ) | (q₃, qₑ) | (q₃, qₑ) | (q₃, qₑ) |

Other Z neurons do not fire. We can see that the DN prediction of Z firing pattern is always perfect, as long as DN has observed the transition (q, σ) from the FA and has been supervised on its Z for q′=δ(q, σ) when the transition (q, σ) is observed for the first time. No supervision is necessary later for the same transition (q, σ).

The prediction for X is similar to that for Z, if the X patterns are binary. Unlike Z, X prediction is not always perfect because FA states are defined for producing the required symbols q, but not meant to predict X perfectly.

Next, let us discuss how the task information is imbedded in a Grand FA, or the control of a Grand TM. Suppose the task information is coded by dedicated neurons, although any action patterns associated with Sᵢ can serve as task context. In symbols, each state has two components q=(q′, q″) where q′ is the task context, and q″ is a state within the task. For simplicity, consider task 3: count whether the number of inputs of T, F, ∧ is even q″=qₑ or odd q″=q₀. Let s₁∈S₁ and s₃∈S₃ be the sensory stimuli for tasks 1 and 3, respectively, but the default is task 1. The Grand transition table is shown in Table IV.

Table V gives the pattern-only transition table. We can see that the mechanism of table lookup is independent of the meanings of the machines inside. Namely, the GENISAMA TM's control DN is for general purposes.

An experienced teacher would teach simpler skills first so that they facilitate the learning of more complex skills later—a process known as scaffolding [122], [139]. In particular, the Grand Teacher TM should teach Tᵢ before teach Tᵤ because the latter calls the former.

TABLE V
Pattern-Only Grand Transition Table for Tasks 1 and 3

| | Input pattern x | | | | |
|---|---|---|---|---|---|
| State pattern z | 101 | 111 | 010 | 011 | 100 |
| 01001 | 01001 | 11000 | 01010 | 01011 | 01110 |
| 01010 | 01010 | 11000 | 01110 | 01110 | 01100 |
| 01011 | 01011 | 11000 | 01110 | 01110 | 01101 |
| 01100 | 01100 | 11000 | 01010 | 01011 | 01110 |
| 01101 | 01101 | 11000 | 01011 | 01011 | 01110 |
| 01110 | 01110 | 11000 | 01110 | 01110 | 01110 |
| 11000 | 01001 | 11000 | 11001 | 11001 | 11001 |
| 11001 | 01001 | 11001 | 11000 | 11000 | 11000 |

The generality of the GENISAMA TM formulation instantiated by the above Table V example casts light on the popular nature-nurture debate [70]. In the formulation, the genome-like (largely nature) DP is body-specific (which may include body-specific inborn behaviors) but task-nonspecific. The DP enables table lookup using exclusively patterns like Table V (which may include tasks and discoveries that the parents never knew). The contents inside the table are task-specific (largely nurture), emerging automatically from the interactions among the external world (sensed and effected environment) through the sensors and effectors, the internal world (inside DN), and the DP. Nature and nurture are inseparable but their roles are clear in the model.

Motivation is very rich. It has two major aspects (a) and (b) in the current DN model. All reinforcement learning methods other than DN, as far as we know, are for symbolic methods (e.g., Q-learning [112], [73]) and are in aspect (a) exclusively. DN uses concepts (e.g., important events) instead of the rigid time-discount in Q-learning to avoid the failure of far goals.

(a) Pain avoidance and pleasure seeking to speed up learning important events. Signals from pain (aversive) sensors release a special kind of neural transmitters (e.g., serotonin [14]) that diffuse into all neurons that suppress Z firing neurons but speed up the learning rates of the firing Y neurons. Signals from sweet (appetitive) sensors release a special kind of neural transmitters (e.g., dopamine [51]) that diffuse into all neurons that excite Z firing neurons but also speed up the learning rates of the firing Y neurons. Higher pains (e.g., loss of loved ones and jealousy) and higher pleasure (e.g., praises and respects) develop at later ages from lower pains and pleasures, respectively.

(b) Synaptic maintenance—grow and trim the spines of synapses [123], [35]—to segment object/event and motivate curiosity. Each synapse incrementally estimates the average error β between the pre-synaptic signal and the synaptic conductance (weight), represented by a kind of neural transmitter (e.g., acetylcholine [143]). Each neuron estimates the average deviation β̅ as the average across all its synapses. The ratio β/β̅ is the novelty represented by a kind of neural transmitters (e.g., norepinephrine, [143]) at each synapse. The synaptogenic factor f(β/β̅) at each synaptic spine and full synapse enables the spine to grow if the ratio is low (1.0 as default) and to shrink if the ratio is high (1.5 as default). Each area X, Y, and Z has a prenatal (default) hierarchy of subareas and subsubareas (e.g. Brodmann areas and its subareas for Y) that continuously adapt postnatally. Each area, subarea, subsubarea, has its own synaptogenic factor. This network of synaptogenic factors dynamically organize the complex brain network (e.g., [22]). See FIG. 2B for how a neuron can cut off their direct connections with Z to become early areas in the occipital lobe or their direct connections with the X areas to become latter areas inside the parietal and temporal lobes. However, we cannot guarantee that such “cut off” are 100% based on the statistics-based wiring theory here.

The experimental results are reported in the following section which shows how we have realized automatic machine learning—fully automatic programming occurs as short transitions of TM. However, the theory here shows that the time-length and the complexity of the learned knowledge are not limited by the methodology.

### IV. Experiments for Auto-Programming

It is well accepted in Artificial Intelligence (AI) that different tasks require different learning methods. The same is true for different sensory modalities. However, auto-programming for general purposes seems to require a learning engine that is task-independent and modality-independent. We provided the Developmental Network (DN) as such an engine to all contestants of the AI Machine Learning Contest 2016 for learning three well-recognized bottleneck problems in AI—vision, audition, and natural languages. For vision, the network learned abstract visual concepts and their hierarchy with invariant properties and autonomous attention. For audition, sparse and dense actions jointly serve as auditory contexts. For natural languages, the network acquires two natural languages, English and French, conjunctively in a bilingual environment (i.e., patterns of text as inputs). All the three sensory modalities used the same DN learning engine, but each had a different body (sensors and effectors). The contestants independently verified the DN's base performance, and competed to add (hinted) autonomous attention for better performance. This seems to be the first task-independent and modality-independent learning engine, which was also verified by independent contestants.

### A. Introduction to Developmental Intelligence

An animal brain is a physical and physiological entity that employs its internal mechanisms to develop itself through lifetime interactions with the external environments. Here “internal” and “external” refers to the skull: inside the skull means internal and outside the skull (include the extra-skull body) is external. The animal body works with the brain to move molecules into and out of the brain as construction elements and energy for metabolism and computation. A mystery of this brain entity—it auto-programs from the physical world for general purposes—has largely escaped research attention in physics, neurophysiology, and computer science, although each individual disciplines have made impressive progress, which has served as the basis of this work. For example, biological brains demonstrated impressive cross-modality plasticity [103], [121] but the computational mechanisms for such plasticity are elusive.

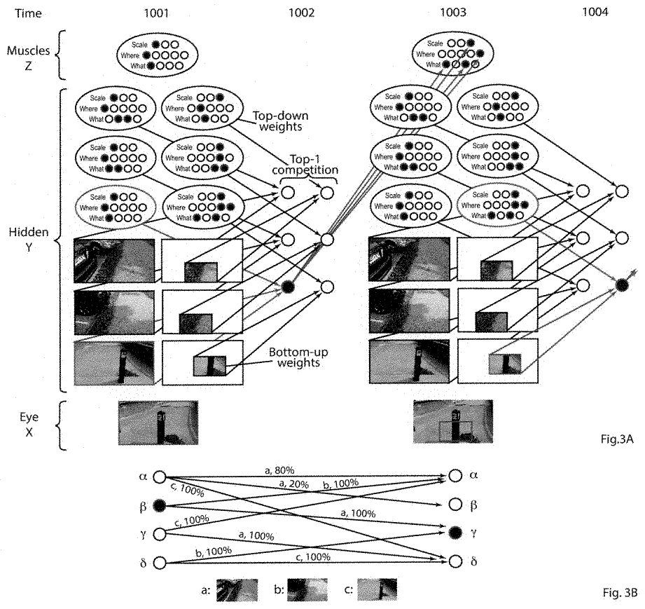

Task-nonspecificity: The DN theory argues that each hidden neuron is sensorimotor, corresponding to a transition in the control of a Universal Turing Machine, which is equivalent to a Finite Automaton (FA) proved in [131]. This learning system is task-nonspecific [137]. FIG. 3A-3B contrasts the major differences between a DN and a traditional network. Each hidden neuron in DN measures not only its weight match with the sensory (bottom-up) input but also the weight match with the motor (top-down) input. The DN always uses muscle signals to supervise (self-supervised or teacher supervised) but the clustering inside the skull is always unsupervised because the skull must be closed throughout the life, not accessible to any teacher for supervision. This mixture of supervision and nonsupervision in a single system requires a new distinction of where a supervision is applied—muscles are supervisable but everything inside the skull is not.

Illustrated in FIG. 3A, the terms like context, state, action, and muscle mean the same in this report—a firing pattern of the Z area of DN. Each term just has a different emphasis.

FIG. 3A-3B conceptually compares the DN with a symbolic network. Put intuitively, a single sentence describes how a simplest DN in FIG. 3A works: All the hidden neurons in the Y area automatically compete for the best match of top-down state as a (binary) pattern in the Z area and bottom-up input as a (real-valued) pattern in the X area, and the winner hidden neuron in the Y area is automatically linked to all the firing neurons in the next (binary) state pattern in the Z area, while all the neurons using Hebbian learning. This simple DN incrementally learns a finite automaton that is the control of a Universal Turing Machine—amounting to auto-programming for general purposes! Using vision as an example, this illustration contrasts between FIG. 3A a simplest DN and FIG. 3B other traditional networks, such as finite automata, Markov models, belief nets, graphic models, Q-learning and many neural networks including deep convolutional neural networks (CNN).

In FIG. 3A a DN has emergent representations for both bottom-up and top-down inputs and uses them for both bottom-up match and top-down match. The firing pattern of many neurons in the Z area corresponds to a state. Namely, a cluster of many patterns corresponds to a symbol like α in in FIG. 3B. But an individual neuron alone does not represent a state. A filled circle indicates a firing neuron and a hollow circle indicates a non-firing neuron. All neurons in the Y area are hidden. Each hidden neuron has a local receptive field for each of the input Z and X areas. Correspondingly, each has a top-down weight vector for Z and a bottom-up weight vector for X. Thus, the nature of each hidden neuron is sensorimotor, not only sensory as with a hidden neuron in CNNs.

In FIG. 3B a symbolic network is representationless for its symbolic states (or class labels in CNN). It does not use emergent representations for states (i.e., an atomic and static symbol, such as α, for each state instead of a pattern) and it does not have any top-down weights for top-down match either. A filled cycle indicates an active (symbolic) state. Such a network cannot do context-dependent (e.g., location-based or type-based) attention like DN because of the lack of top-down match weights.

Modality-nonspecificity: Auto-programming for general purposes also requires a set of learning mechanisms that are applicable to a wide variety of sensory modalities and motor modalities. This paper reports how the DN applicability to the three sensory modalities—vision, audition, and natural languages—supported by the DN theory were verified by independent contestants of AIML Contest 2016 whom were supplied with the base DN source programs and open-ended sensorimotor data sequences for all the three sensory modalities. The DN applicability also supports a wide variety of motor modalities, such as navigation, declarative skills (e.g., verbal story telling) and non-declarative skills (e.g., riding a bike) [110], and meaning states in natural languages.

Weng [125] argued that tasks using three modalities—vision, audition, and natural language—are highly muddy because of the high composite muddiness of each modality, as a product of 26 muddiness measures in five categories [125], but computer games [29] are very clean tasks in such a composite muddiness.

Although it has been widely accepted that these three modalities use very different learning mechanisms, the AIML Contest 2016 appears to be the first contest that used a general-purpose learning engine that is both task-independent and modality-independent. Here modality means sensory modality (e.g., vision, audition, text) or motor modality (e.g., verbal or navigation). Namely, the learning engines are the same, but the resulting networks are different. This is because the general-purpose engine develops a very different network for each modality.

Program vs. data: Traditionally, the input tape of a Universal Turing Machine consists of two artificially partitioned parts—program and data. The program consists of instructions for the machine to follow. The data are for the program to apply the instructions to. But for developmental learning—both natural and artificial—such a rigid distinction between program and data is undesirable. For example, an image corresponds to data because it contains data for the detection of road; but such an image also corresponds to instructions because the road amounts to a navigation instruction (i.e., follow the road). Namely, instructions and data are in the physical environment, inseparable.

Training vs. testing: Traditionally, machine learning is divided into two separate phases, training and testing. Developmental learning, also the AIML Contest, integrates these two phases into a single “life” experience—each learning agent “lives” through interactions with an environment that provides a long sequence of sensory and motor frames each of which can be considered instructions, data, or a mixture thereof. The system always tries to provide an action output at each frame which may change the environment. At every time frame, the system learns if the environment supervised the motor. Otherwise, the system performs and the error is recorded if there is any. Namely, scaffolding [139] takes place automatically through the “life”—early learned skills automatically assist later learning of probably more complex skills.

Resource limit: Traditionally, a contest allows the competitors to use as much computational resource as possible so that the competition amounts to a resource competition to a considerable degree (e.g., with a human competitor), such as the contests that involve IBM Deep Blue, IBM Watson, AlphaGo, and ImageNet. However, the AIML Contest limits the total number of hidden neurons used by each contestant, so the contestants have the freedom of creatively using the allowed number of hidden neurons.

The competition: The main competition among the teams of the AIML Contest 2016 is as follows. From the organizer-supplied attention-free DN source program with a base performance for each of the three modalities, improve the base performance averaged over the three modalities, one system for each modality.

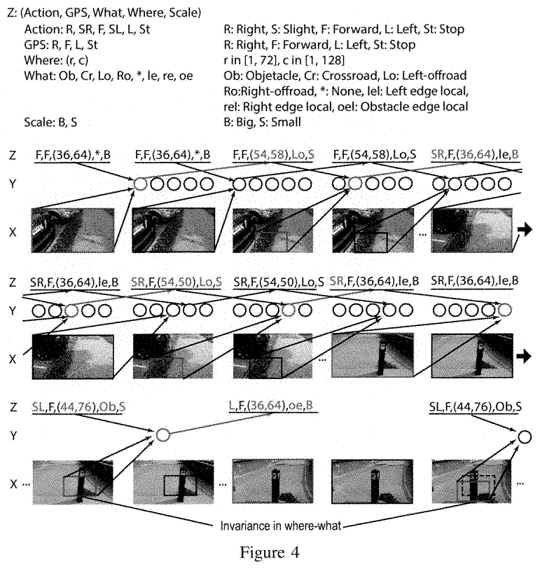

The vision task is autonomous navigation on the MSU campus, where GPS signals are often missing, not accurate enough, and will lead to failures without a sufficient visual capability using a single video camera. As an option, the organizer provided an extensively explained hint along with the illustration in FIG. 4—how to add the attention mechanisms for vision without adding more hidden neurons. The audition and natural language tasks of the Contest do not have large “background” distractors like video, other than disjoint sensorimotor experiences that arise from auditory variations and natural noise.

FIG. 4 provides A task-specific and modality-specific example of how a task-nonspecific and modality-nonspecific engine learns.

Vision modality: a DN learns concepts like where, what, scale and navigation actions, while learning an attention sequence global, local, global, local . . . but any arbitrary attention sequence can be learned in a similar way. The DN has three areas, the sensory area X to take images, the hidden area Y, and the state area Z. The discrete time t increments by 1 from left to right, and continues in the following rows.

Top panel of FIG. 4: A hierarchy of concepts in the Z area incrementally taught by the environment. The Z area has been taught 5 concept zones, Action, GPS, Where, What, Scale. Each concept zone has several taught values, such as right, slightly right, etc. for the Action concept zone. For simplicity of illustration, each concept zone has only a single neuron firing, but multiple neurons may fire in general.

Lower panels of FIG. 4: auto-wiring in DN to become a detector-recognizer-navigator. Neurons (circles) at each discrete time t only take input from the previous time t−1, t=1, 2, . . . The discrete time passes from left to right, and continues in the lower panels. Y neurons are generated one at a time before reaching the limit. Z neurons are supervised (teaching) or free (performing) at any time. Each Z response at time t is a vector; symbols are only for visualization. All (hidden) Y neurons compete to fire, and the winning neuron corresponds to the current bottom-up attention (for the winner image patch in X) and the top-down attention (for the winner context in Z). (1) Each new Y neuron uses the input (bottom-up and top-down) to initialize its weight vector, to represent a transition in the Turing Machine control. (2) After all Y neurons have been initialized, each hidden winner neuron, only when it wins, computes the optimal weight vector which is incrementally computed average of all input vectors observed so far. Both (1) and (2) mean that DN is always optimal in the sense of maximum likelihood. The location invariance of the “what” neurons is learned from observing many (not exhaustive) locations; the scale invariance of the “what” neurons is learned from observing many scales (not exhaustive). We avoid convolution since the hidden representations are sensorimotor, not sensory only. Similarly, any concept is invariant to all other concepts. The last row: the Y neuron (red) was used to detect a similar feature type at a different but similar location under a similar Z context. Audition modality: the X area has a firing pattern of the simulated hair cells in the cochlea. Natural language modality: the X area has a binary pattern representing a text (word or punctuation).

The contest results: The first place team and our in-house version implemented such attention mechanisms for the vision modality, having reduced the base error 26.4% for vision by 56.3% and 80.3%, respectively. Compared with other teams, the implementation of this hinted attention appeared to be the primary reason for the first place team to stand out. Many methods, other than attention, tried by the first place team did not show any improvements probably because the base program is already optimal in the sense of maximum likelihood.

The main reason that the in-house version performed better than the first place team is that it has additionally synaptic maintenance explained in the companion report where each hidden neuron automatically cuts off input lines that do not match the weight well, amounting to automatic cutting-off background pixels that “leaked” into all hidden neurons.

For the other two modalities, audition and natural languages, the lifelong average errors of the DN base engine supplied to the contestants were 11.5% and 4.9%, respectively. Contestants have not reported any considerable improvements for these two modalities. This is reasonable because the audition modality has only one human speaker, and the language modality has only one stream of text. Therefore, the attention-free DN seems to be optimal.

The implication of these two companion reports is interesting not only to AI and computer science, but also to physics and neurophysiology. Researchers in physics [40], [69] and neurophysiology [34], [22], [96], [48], [15], [47] have been attracted to dynamics, anatomy and “modules” in the brain. The results here seem to favor an absence of any clear-cut physical boundaries of “modules”. The reader is referred to Weng 2012 [127] for biological relevance of the absence of such clear-cut boundaries. The theory and the independently verified experiments have established that there is a new kind of entity, simulating physical processes and physiological processes, that auto-programs based on the physical world, where the automatically wired circuits have well-understood logic of a huge emergent Turing Machine that is optimal.

In particular, this work questions the “place cell” interpretation of the Nobel-awarded experiments [78], [77]: The “place cell” interpretation is task-specific and setting specific. The theory here predicts that the same hippocampal cells in [78], [77] should also fire in many other task settings that have little to do with sensory “places”, e.g., fighting and mating. Furthermore, such “place cells” should also depend on actions, not just sensory signals (a place), because they represent sensorimotor contingencies. We wait for future experiments to confirm or refute these two predictions here.

We have not addressed all details of a developing brain. In particular, the lateral connections within the hidden Y area are simulated by the top-k competition (inhibitory). This limitation will be lifted by the future version DN-2 which includes also excitatory connections among Y hidden neurons. This lift will enable a DN to generalize better.

### B. Experimental Methods

Research communities: We first relate the new methods here with the major existing work in the literature and the status quo in the related research communities so that the reader can see what popular conventional thoughts we must overcome first.

Many researchers have separated vision from action. In 1983 a well-known conference series that has computer vision in its name, the Computer Vision and Pattern Recognition (CVPR) Conference series was born from its precursor conference series Pattern Recognition and Image Processing (PRIP). Three years later, 1987, the International Conference on Computer Vision (ICCV), came into existence. They marked that the computer vision community consciously separated itself from then a well-known conference series called the International Joint Conference on Artificial Intelligence (IJCAI).

Likewise, in robotics, psychology, and neuroscience, many researchers have separated language production from actions. Psychologists have named two types of skills [110], declarative skills that can be declared using a certain language (e.g., verbal storytelling), and non-declarative skills (e.g., bike riding). However, Wu & Weng 2017 [140] argued that declarative skills and nondeclarative skills all emerge through muscle neurons (note: not just motor neurons). In AIML Contest 2016, actions of navigation and states of natural languages all correspond to simulated muscles.

The journey that led to this work has covered a considerable distance. Let us first recall the first departure.

The first departure: The first departure was made by Cresceptron 1993 [133] that dealt with a 2-D image of many 3-D objects, but without any monolithic 3-D object model inside the network at all.

Neocognitron by Fukushima 1980 [27] was a handcrafted network that, although does not learn, classifies images each of which contains a single hand-written numeral (from 0 to 9). Inspired by Neocognitron, a deep-learning convolutional neural network called Cresceptron 1993 [133], 1997 [134] appears to be the first that used a deep convolutional network to learn, to detect, to recognize, and to segment learned 3-D objects from 2-D images each of which contains many other objects. Since Cresceptron, we have not seen many systems that do detection, recognition, and segmentation altogether. Instead, we have seen many systems that do only classification of 3-D objects from 2-D images without telling which is which.

Cresceptron 1993 is also the first network that dealt with 2-D images of 3-D objects without any monolithic 3-D object model inside the network—a major difference from then a popular method called aspect graphs that requires a monolithic 3-D object model. This was methodologically different from the earlier 2-D work of Fukushima 1980 [27] and more recent work of LeCun 1998 [62] and Hinton 2006 [39] that used deep convolutional networks to deal with handwritten characters because handwritten characters are intrinsically 2-D.

This major departure initiated by Cresceptron 1993 away from 3D-model based vision has not been credited by many later publications that used this key idea to classify 2-D images of 3-D objects, including Tomaso Poggio 2002 [91] and 2007 [102], Li Fei-Fei 2005 [20], 2006 [21], many of those that published CNN work for ImageNet contests, and some recent review articles [61], [50]. Although the first departure has been widely practiced, the second departure has not yet.

The second departure: The second departure is away from CNNs. Although deep CNNs with error back-propagation learning have become popular [99], [61], [50], the DN engine verified by AIML Contest 2016 avoided the use any of the following popular techniques that are hallmarks of CNNs:

(1) Convolution: Convolution means every layer is sensory only, instead of sensorimotor in DN. In DN, sensorimotor representations enable learning abstraction with invariances without the leaky “strides” [134].

(2) Master map [113]: Using an attention window with different scales, Cresceptron extracts many image patches at different pixel locations and with different scales. First normalize the scale of the image patch to become a master map and then apply the network to the master map. Instead, a DN learns from an autonomous and recurrent sequence of attention without any master map. In FIG. 4, each attentional fixation (e.g., global) provides cues (e.g., location, type, and scale) of the next attentional fixation (e.g., local) and so on. Namely, learned dynamic attention skills avoid the intractable exponential complexity [115] of the hypothetical master map [113], [79]. Furthermore, such dynamic attentional fixations are not only about pixel location and scale, but also about other concepts such as feature type, and any subset thereof.

(3) Error back-propagation for learning: (a) No error is available at the baby's muscle ends and (b) the gradient-based error back-propagation indiscriminately erases long-term memory from neurons that are not responsible for the current context. The optimal Hebbian learning enables a DN to be “skull closed”—all hidden learning is fully “unsupervised” but external actions always self-supervise the network.

(4) Max-pooling first proposed and used by Cresceptron as confirmed by [99]: The function of max is still pixel-oriented, but each DN's hidden neuron is sensorimotor, not just sensory. The max-pooling leaves many “holes” in the network as explained in [134].

Why? Few researchers have paid sufficient attention to the criticism from Marvin Minsky that neural networks are scruffy [72] and the criticism from Michael Jordan that neural networks do not abstract well [31]. The departure by DN has addressed these criticisms: A DN abstracts well, mastering probably the most powerful logic (not scruffy) known to the human race—Universal Turing Machines.

The AIML Contest 2016 is different from existing contests in that it is task-independent and modality-to independent, supported by the theory in the companion report and inspired by human the simple-to-il complex development called lifelong development [137]. Furthermore, DN is different from evolutionary algorithms in that each network must develop successfully and optimally inside the “skull”—We do not try many networks and report only the one that performs the best.¹ ¹ Life is Science 10. Weng's Facebook blog.

In order to understand both departures, next let us look at the fundamental issue of representations.

Symbolic vs. Emergent: By symbolic [128], we mean that each entity (state or input) is a symbol, point, not breakable as illustrated in FIG. 3B where each symbol does have meanings, but such means are in the design documents, not part of the network. Each symbolic input in FIG. 3B is probably not symbolic originally—a pattern instead. However, as soon as the pattern is classified as a symbol (a, b, or c), the network uses only such a symbol, and the pattern is never part of the network. In contrast, DN in FIG. 3A has not only emergent weights as a pattern to match a bottom-up input pattern, but also emergent weights as a pattern to match top-down input as a pattern of context. A DN can attend a subset of elements in the input pattern (in X and Z respectively) while its corresponding hidden Y neuron wins as the best match that integrates both top-down match and the bottom-up match.

Each hidden neuron in FIG. 3A uses the optimal Hebbian mechanism to update its bottom-up and top-down weight vectors if the hidden neuron wins in top-1 competition of the match, but loser neurons do not fire and do not update their weights. Each Z neuron, if it is supervised to fire or wins to fire, updates its bottom-up weight vector using the same optimal Hebbian mechanism. This unified optimal Hebbian mechanism results in a closed-form, non-iterative, incremental, optimal solution to both weights and responses at every discrete time, proved in Weng 2015 [131].

In contrast, each node of a symbolic network in FIG. 3B does not yet have a known closed-form solution to its symbolic probabilities. Their weight update methods [86], [124] are iterative, not time-incremental, and only converges to a local extremum.

However, because an emergent representation is a pattern, a critical capability is necessary for general purposes: attention—attending to one of many subsets of the pattern, e.g., attending to an object in an image.

Attention: Context-based attention is difficult to learn if the entire hidden area has a rigid structure constraint, such as a deep cascade of modules, such as a vision module, a master map module, a decision-making module, and an action module, all linked as a cascade. Instead, each hidden neuron in FIG. 4 can learn from not only the sensory area X but also actions in area Z. Yet, there is not such a cascade of modules.

The Z area provides the current context vector, which boosts precisely the corresponding Y neurons, through hidden neurons' top-down weight match, and thus the system attends the image patch corresponding to the winner hidden neurons. In neuroscience, top-down projections from motor areas have been roughly called feedback, modulation, or diffused turning, e.g., [79], [12]. The top-k mechanism in the hidden area of DN avoids a hypothetic “master map”, unlike [113], [79].

In particular, although now popular in industrial interests, the cascade deep architecture in Neocognitron 1980 for single 2-D numerals [27], Cresceptron 1993 for 3-D objects in cluttered scenes [133], [134], and other later deep learning networks (e.g., [62], [90], [101], [39], [55]) have a fundamental limitation: A cascade architecture, which is incapable of autonomous attention in FIG. 4. Their use of convolution further defeats abstraction (e.g., all layers are sensory, not sensory-and-motor as in FIG. 4 because motor can be “abstract”) and prevents optimality (e.g., the worsened absence of shift-invariance for big patches under resolution-reduction and max-pooling, as analyzed in [134]).

Why autonomous attention? Without autonomous attention through time, the so-called “immediate vision” [115] and bottom-up attention under a free-viewing hypothesis [43] face an exponential complexity argued by Tsotsos [115]. In contrast, as analyzed by the companion report, DN with spatiotemporal-context driven attention (see FIG. 4) has a surprisingly low linear complexity. Thus, a system for real:time, general-purpose, learning-while-performing vision could become practical.

We are now ready to discuss sensory modalities. In the following, we will discuss three modalities—vision, audition, and natural language (patterns of text as input).

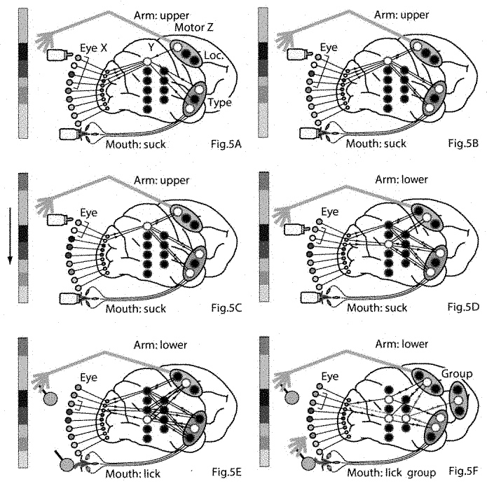

Vision from a “lifelong” image sequence: FIG. 5A-5F gives a schematic and intuitive illustration for the major theory in the companion report using vision as an example, but the learning engine is modality independent. FIG. 5A-5F explains Why vision requires autonomous actions:

A GENISAMA TM emerges as automatic wiring and skill representation inside DN, synthesized from a series of new experiences. The physical body (e.g., both sensors and effectors) and the physical world (e.g., the change from each action) must work together to abstract new concepts (e.g., location and type) from real-time concrete examples and to further abstract higher relation concepts (e.g., group) from lower concepts (e.g., location and type).

In FIG. 5A Object 1 (milk bottle). The arm is holding it (location 1) and the mouth is sucking it (type 1). The first Y neuron genesis. The receptive field is too large.

In FIG. 5B the Z neuron genesis in the Location Motor area and the Type Motor area, respectively. In FIG. 5C background changes enable the Y neuron to automatically trim the receptive field, resulting in automatic object segmentation. FIG. 5D the bottle moved (location 2). The arm is holding it (location 2) and the mouth is sucking it (type 1). The 3rd Y neuron is assigned for this receptive field (trimmed) and the corresponding location context (location 2) and type context (suck). FIG. 5C to FIG. 5D indicate how type motor neurons become location invariant after the corresponding object (milk bottle) has been moved to different locations.

FIG. 5E Object candy. The arm is holding it (location 2) and the tongue is licking it (type 2). The 4th Y neuron is assigned to it with the Z state. FIG. 5D to FIG. 5E indicate how location motor neurons become type invariant after different objects appear at the same location. FIG. 5F: Later Y neurons (3rd in the 2nd Y layer) can have larger sensory receptive fields by directly connecting with X and/or early Y neurons (2nd and 4th of the 1st Y layer). “Early” means the X area or more direct connection with the X area. The synapse maintenance can retract the synapses connected to earlier areas (X in this case, dashed lines) and have inputs from only abstract areas (location and type), resulting in a more complex concept—group in the Group Motor area—independent of appearances in X.

The “building blocks” for the DN control are FA transitions—from the current motor-sensory pattern as vector (z, x)=(z(t), x(t)), where z and x are binary firing patterns in the motoric Z and sensory X ports, respectively, the firing pattern y of the Y area as a transitional “bridge” pattern [129] that helps to predict the next binary patterns (z′, x′) in Eq. (3) which we rewrite here because of its importance:

$$[ \begin{matrix}z \\ x\end{matrix} ] \to y \to [ \begin{matrix}{z}^{′} \\ {x}^{′}\end{matrix} ]$$

where the y vector is an n-dimensional binary vector, if Y has n hidden neurons.

Learning takes place only within every firing neuron in X, Y and Z, using a Hebbian mechanism. Using the firing age to determine its learning rate and retention rate automatically, so that the weight vector v of each neuron is always the average of all its observed input p, incrementally computed only at each time t when the neuron wins and fires.

As illustrated in FIG. 5A-5F, auto-programming takes place while the agent “lives” in the physical environment. The body jointly with the physical environment serves as a “teacher” that supervises DN at every time t.

After the above example, we are ready to discuss the vision modality in the AIML Contest, as Mus-ic, trated in FIG. 4. Applying the model in the companion report, we model a general-purpose visuomotor system in space-time to be an Emergent Turing Machine that performs the operation in (3).

The human teacher had a set of concepts that he plans to teach the machine, as shown in the upper panel in FIG. 4. However, those symbolic notations are only for the human reader. The DN only takes patterns, images in the X area and concept patterns as context in the Z area. The middle row illustrates how new Y neurons are added as soon as a near-perfect match is not found among all current Y neurons.

The supplied DN for all contestants has only global view: each Y has complete connection with all pixels in X. Hints from the organizers are provided to all the contestants.

For example, one major hint is about attention: A global view provides context for the next local view where the natural landmark (road edge) is roughly. located. The local view allows the detection of the type and location of the landmark, which enables the generation of the navigation action. As the hint, FIG. 4 is provided to all the contestants so that they modify the DN so that Y neurons have different receptive fields.

As another example, a hint is about shifting each supplied image to generate additional training images so as to develop invariance for the where and what concepts for better generalization as indicated by the last row of FIG. 4.

FIG. 6 provides an overview of the extensiveness of the training, regular training, and blind-folded testing sessions.² The inputs to the DN were from the same mobile phone that performs computation. They include the current image from the monocular camera, the current desirable direction from the Google Map API and the Google Directions API. If the teacher imposes the state in Z, this is treated as the supervised state. Otherwise, the DN outputs its predicted state from Z. The DN learned to attend critical visual information in the current image (e.g., scene type, road features, landmarks, and obstacles) depending on the context of desired direction and the context state. Each state from DN includes heading direction or stop, the location of the attention, and the type of object to be detected (which detects a landmark), and the scale of attention (global or local), as shown on the upper panel of FIG. 4, all represented as binary patterns. None is a symbol. The dataset used in the AIML Contest contained 2109 gray-scale images of 72×128 pixels that have been converted down to 38×38 pixels for the DN to learn and test. ²Youtube video at https://www.youtube.com/watch?v=4cc9xk0TaxE.

The wide variety of visual scenes along the extensive walkway routes in FIG. 4 presented many great challenges to this camera-only system without using any laser device. For example, if the DN simply attends the entire image only, the match of past experience in the limited-size DN is bad for new walkways. This is a task setting for which a general-purpose visual learner with context-based attention has been absent till now. Clearly, general-purpose learning of local landmarks is a key, because only landmarks (e.g., texture of road borders and obstacles) are similar in new walkways, not the entire new image! However, the entire new image gives clues for where and what to attend next to find a useful landmark!

However, many features can be a landmark and a landmark may appear at different locations! The former requires general-purpose object recognition and the latter demands general-purpose object detection. The DN carried out both simultaneously based on its learned context, according to the emergent automata theory in the companion report, without a vision programmer! In order to reach location invariance and type invariance for all attended landmarks, our in-house version used additional images that were automatically generated from the available sequence through a variety of image shifts (left, right, up, down), along with the correspondingly “shifted” actions. These additional virtual experiences simulate more “life like” experiences that are necessary for the DN to abstract invariant concepts, such as location, type, and scale, from many attended concrete image patches. Only 2000 hidden neurons were allowed for the Contest.

It seems impractical to hire humans to effectively translate the implicit numerical rules inside the DN in FIG. 4, because those rules are too muddy and too many. Therefore, auto-programming seems to be necessary for strong vision.

Supported by the model in the companion report, we summarize some points: (1) A DN has no rigid or clear boundaries among vision, decision making, and actions. (2) The information flow in DN is neither feedforward nor cascade as brain anatomy has told us [22]. (3) Each hidden neuron in DN serves for transitions like those in an emergent Turing Machine (TM), i.e., statistical.

Audition from a “lifelong” cochlear sequence: For the audition modality, each input image to X is the pattern that simulates the output from an array of hair cells in the cochlea. We model the cochlea in the following way. The cells in the base of the cochlea correspond to filters with a high pass band. The cells in the top correspond to filters with a low pass band. At the same height, cells have different phase shifts. The detail of the parameters of each frame is available in [140]. Potentially, such a cochlear model could deal with music and other natural sound, more general than the popular Mel Frequency Cepstral Coefficients (MFCCs) that are mainly for human speech processing.

It is important to note that it is necessary for a developmental agent to learn from early baby babble. Therefore; real phonemes were recorded as auditory stimuli.

The same DN learns the auditory emergent finite automaton. The auto-programming of DN is determined not only by X inputs, but also the Z inputs which are temporally dense action patterns with two concepts. Concept 1 is the state, based on 40 clusters of individual frames. There are a total 177 states, as states in FA, similar to the states for natural language acquisition below. A state carries useful information about both time duration (e.g., between /i:/ and /i/) and the context from the beginning (silence state) of the phoneme. Concept 2 is the type of the phoneme near the end of each phoneme.

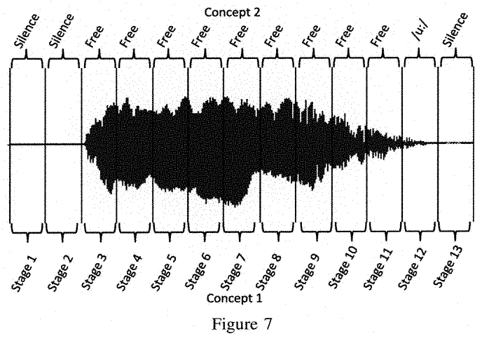

Take /u:/ as an example shown in FIG. 7. The state of concept 2 keeps as silence when inputs are silence frames. It becomes a “free” state when phoneme frames are coming in, and changes to /u:/ state when first silence frame shows up at the end. At the same time, the states of concept 1 count temporally dense stages.

With the exact training sequence as input (re-substitution), the output was nearly perfect. With new inputs that are not the same as any of the training sequences (disjoint), the average error of phoneme action (concept 2) is 23% if the dense action (concept 1) is not used. Using the dense action (concept 1), the average error of phoneme action (concept 2) was reduced by 46% to 12%. Only 335 hidden neurons were allowed for learning 44 phonemes. The more hidden neurons are allowed, the smaller the expected average error.

Natural languages from a “lifelong” word sequence: As far as we know, this seems to be the first work that deals with language acquisition in a bilingual environment, largely because the DN learns directly from emergent patterns, both in word input and in action input (supervision), instead of static symbols.

The input to X is a 12-bit binary pattern, each represents a word, which potentially can represent 2¹² words using binary patterns. The system was taught 1,862 English and French sentences from [100], using 2, 338 unique words (case sensitive). As an example of the sentences: English: “Christine used to wait for me every evening at the exit.” French: “Christine m'attendait tours les soirs à la sortie.”

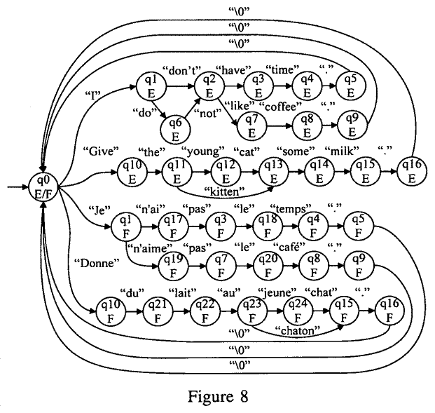

The Z area was taught two concepts: language type (English, French, and language neutral, e.g., a number or name) represented by 3 neurons (top-1 firing), and the language-independent meanings as meaning states, as shown in FIG. 8. The latter is represented by 18 neurons (18-bit binary pattern), always top 5 neurons firing, capable of representing C(18, 5)=8,568 possible combinations as states, but only 6, 638 actual meanings were recorded. Therefore, the Z area has 3+18=21 neurons, potentially capable of representing a huge number 2²¹ binary patterns if all possible binary patterns are allowed.

However, the DN actually observed only 8,333 Z patterns (both concepts combined) from the training experience, and 10, 202 distinct (Z, X) patterns—FA transitions. Consider a traditional symbolic FA using a symbolic transition table, which has 6,638×3=19, 914 rows and 2,338 columns. This amounts to 19, 914×2,338=46 558, 932 table entries.

But only 10, 202/46, 558,932≈0.022% of the entries were detected by the hidden neurons, representing that only 0.02% of the FA transition table was observed and accommodated by the DN. Namely, the DN has a potential to deal with n-tuples of words with a very large n but bounded by DN size, because most un-observed n-tuples are never represented. The FA transition table is extremely large, but never generated.

Without adding noise to the input X, the recognition error is zero, provided that there is a sufficient number of Y neurons. We added Gaussian noise into the bits of X. Let a represent the relative power of the signal in the noisy signal. When α is 60%, the state recognition rate of DN is around 98%. When a is 90%, the DN has reached 0% error rate, again thanks to the power of DN internal interpolation that converts a huge discrete (symbolic) problem into a considerably smaller continuous (numeric) problem.

The AIML Contest used about a half of the sentences from the above in-house experiments. Only 5, 145 hidden neurons are allowed for the Contest, reaching 4.9% average error in states.

Again, as the only difference from the above two modalities is the patterns in the X area and the Z area, the same DN learns the word inputs and the supervised states.

### V. Auto-Programming Operating Systems (AOS)

Based on the theories, methods, devices, and experiments explained above, this section presents a new kind of OS—Auto-Programming Operating Systems (AOS).

The AOS provides a software interface between a human user and the DN learning engine so that the human user does not need to know the detail of DN, like a mother who does not need to know detail inside a child brain in order for her to teach the child. The mother teaches the child many tasks, from simple to complex, but she never does programming. The auto-programming takes place inside the brain (DN) throughout lifetime.

### A. Why AOS?

The purposes of AOS are twofold:

First, make strong AI. Weak AI is AI that is for a narrowly defined task. Strong AI is AI that is meant to learn and perform many different tasks in the natural world. Weak AI is not only limited in the scope of the task that the machine executes, but also brittle if the task is a real-world task, such as self-driving in the natural world.

Second, make machines work and learn more like a human. For example, suppose one prints a file that includes 10 pages. A traditional printer is not able to abort the printing task once the task has been started but the toner is run out in the middle, or the long file being printed turned out to be a wrong one. A human can change his goal in real time on-the-fly according to a new situation, but a traditional printer cannot. The AOS abstracts all sensors and effectors as real-time sensors and effectors, so that the DN can change the task at hand within a fraction of second. Changing the goal on the fly is not only important for aborting a task, but also for adjusting sub-goals within a task. For example, how to adjust the pitch, volume, duration and other sound characteristics depending on how the machine likes what it hears from its singing.

By definition, an agent is something that senses and acts. Inside the agent are three types of resources: sensors, effectors, and computational resources. For convenience of the three-type classification, anything that is not sensor or effector is considered computational resources. Therefore, e.g., batteries can be considered part of computational resources.

Because AOS is for auto-programming for tasks without a static scope, we must not assume any task concept. However, AOS should abstract the agent body so that a DN can plug into any computer and start to “live” and learn.

The new method and device of AOS deal with the following issues:

1) Convert every input device to a unified sensor with a set of parameters (e.g., the number of pixels).

2) Convert every output device to a unified effector with a set of parameters (e.g., the number of possible values).

3) Convert all computational resources to unified neurons and their connections.

4) Provide a mapping for each change in the physical sensors, effectors, and computational resource in the body so that the trained DN can continue to learn on the new body.

Body changes may take place at different lifetimes of a (machine) brain—the Developmental Network. For example, a machine brain successfully trained on a factory body is copied into many identical machine brains (DNs) each of which is then uploaded to a different machine body by a consumer. A version 1 body is upgraded to version 2 body, and therefore, the machine brain must run on the new body.

Like a human being, the learning of a strong AI system must go through a process of learning many tasks—from simple to complex—so that skills learned for simple tasks assist the learning for complex tasks. For example, learning to stand steady can assist learning walking without falling. Learning walking is useful for learning running. Sometimes, the skills learned for complex tasks can also assist the learning of simpler tasks. For instance, in mathematics, skills in learning derivatives can also assist learning limits (e.g., L'Hospital's Rule).

### B. Traditional OS

An operating system (OS) is system software that manages computer hardware and software resources and provides common services for computer programs. In the context of operating systems, input devices and output devices are called peripherals. Traditionally, an operating system (e.g., Unix, DOS, Mac OS, Windows, iOS, Android) treat each peripheral differently using a different driver.

A traditional OS treats a keyboard and a camera using two very different drivers because the keyboard and the camera are two very different input devices.

A traditional OS treats a printer and a speaker (or other effectors such as one that controls the steering wheel of a car) using very different drivers because the printer and the speaker are two very different output devices.

A traditional OS treats computer resources very differently, such as memory, disk, CPU and GPU.

### C. AOS

The main purpose of AOS is to provide a unified standard for any Developmental Network (DN) that auto-programs for general purposes. Although each computer has different hardware and OS, AOS abstracts all hardware and OS into a single standard in order for any AOS-complaint DN to plug in and start learning as a GENISAMA TM.

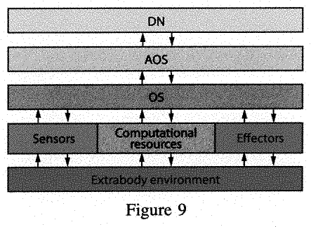

Shown in FIG. 9, an AOS is built on top of a conventional OS such as Unix, Android, iOS, and Windows which provides some basic functions about the resources, such as recording, playing back, programming, and search.

The theories, methods and experiments above have given detailed examples about how an AOS converts three types of resources—sensors, effectors, and computational resources—into unified sensors, unified effectors, and unified neurons, respectively. Because there is an open-ended variety of physical sensors, effectors, and computational resources, it is desirable and sufficient to give the following principles of AOS.

AOS unified sensors: AOS provides AOS standards and sample methods to unify all current and future sensors. Examples of sensors include: video camera (real-time image sensors), microphones (real-time sound sensors), touch screens (real-time touch sensors), lasers, radars, sonars (real-time distance sensors), keyboards (real-time finger-touch sensors for body symbols).

Each instance of connected sensor provides an abstract sensor, called AOS body sensor. At each sampled time, each sensor provides a body-sensed pattern, represented as a numerical image (typically 2D for a gray-tone camera or 3D for a color camera) where each pixel corresponds to a body-location of a receptor in the sensor and the intensity of each pixel corresponds to the firing value of that receptor. Two cameras are treated as two sensors whose field of views have partial overlap in the 3D physical world. Pixels in the binocular areas are considerably correlated between the left camera and right camera. It is desirable for DN to automatically form connections in a coarse-to-fine manner through lifetime using synaptic maintenance so that neurons automatically find their locations in the artificial retinas and whether it is a binocular neuron, a left-monocular neuron, or a right-monocular neuron [107], [108]. Other differences between the DN sampling rate and the sensor sampling rate should be treated the same way by AOS.

Because the update rate of a DN (e.g., 30 Hz) is considerably lower than the sampling rate of a microphone (e.g., 44,000 Hz), a sampled body-sensed image from a microphone integrates the between-frame (e.g., 33 ms) spatiotemporal information of all hair cells in a cochlea [141]. Namely, an AOS image from a microphone and an AOS image from a camera are basically the same in data format, called AOS sensory image: e.g., both are images provided at 30 times per second. The major differences between them are the number of pixels and the nature of the physical properties (i.e., sound vs. light).

AOS unified effectors: AOS provides AOS standards and sample methods to unify all current and future sensors. The data format of an AOS effector is also an image, called AOS effector image.

Just like AOS sensors are body sensors, all AOS effectors are body effectors. By body effector, we mean that each component in the pattern of an AOS effector corresponds to a body muscle on the body, instead of value of a concept in the extra-body world. The purpose of this requirement is to avoid handcrafted extra-body concept in the representation of AOS effectors. However, we allow the environment to teach any patterns of world concepts through sensors and effectors. For example, we allow the environment to teach a component in the steering wheel effector that corresponds to a particular speed value or a particular angle value of the steering wheel (i.e., simulating the arm that turns the steering wheel).

The sampling rate difference between DN and an effector (e.g., a loud speaker) is treated in a way similar to sensors. The image generated for a speaker contains information to drive the speaker for the inter-frame time (e.g., 33 ms from a 30 Hz DN). AOS body speaker is not a conventional static text-to-speech synthesizer. Because it simulates muscles, the DN can generate different sounds (e.g., singing) according to its spontaneous intents or goals.

AOS unified computational resources—neurons: AOS provides AOS standards and sample methods to unify all current and future computational resources. The basis of the standards and sample methods are the architecture of DNs, explained above. All computational resources serve neurons as the basic computing elements. Each neuron requires memory (registers, RAM, disk, etc.) to store its dynamic weights and its dynamic connections with other neurons. Each neuron also requires memory to store its dynamic age and growth rates. Each neuron requires computing resources (CPU, GPU, FPGA, etc.) to carry out its computation for its current response and its current values of neural transmitters through excitatory neural transmitter, inhibitory neural transmitter, 5-HT, DA, ACh, NE (see Weng [127]).

The memory hierarchy (e.g., the register-RAM-disk hierarchy) in a traditional OS meets changes here because it is possible that every weight of all neurons would be used to compute the real-time neuronal competition, regardless whether the neuron itself fire after the computation of competition. Such brain-like parallel computations require a high speed of computation and data transmission by hardware (e.g., CPU, GPU, FPGA, dedicated neuronal circuits, and data bus) and a large amount of fast memory.

### D. Hardware Changes

Let us consider difference of hardware. Such a difference may occur between a training machine in the robot school run by a factory and a customer machine. This can be treated basically the same as a body change within the robot school: The partially learned DN is downloaded from the old body, recompiled with the AOS on the new body, and continues to run (i.e., learn and perform) the old DN on the new body, in a way similar to a human who changed to a new pair of eye glasses. A minimal degradation of performance may be observed like the human who got a new pair of eye glasses.

The hardware changes modeled by AOS include resolution change (increase or decrease), a range change (increase or decrease), a depth change (e.g., from black-and-white to color), or a combination thereof, from the prior pattern to a new pattern in the AOS sensory image or the AOS effector image. AOS specifies a mapping standard and sample methods between the old pattern to the new pattern:

Uniform sensors and effectors: For a sensor, the density of receptors is uniform across the sensing array. For an effector, the muscle neurons are uniform. There is no need to calibrate the new camera, because the DN is able to adapt, like how human eyes learn to adapt to a new pair of glasses. Suppose that the new pattern has doubled the number of pixels, in both row and column, from the old pattern. The AOS handles this case by initially connecting one of every 2×2 pixels in the new pattern to the corresponding pixel in the old pattern. The growth of Y neurons in DN will gradually spread its neurons over the entire new pattern. A similar principle applies if the new pattern reduced the resolution: Linearly spread the pixels in the new camera evenly across the old input pattern by skipping an old connection every n pixels, where n=2 if the resolution is reduced by 2 in the direction from the old pattern to new pattern.

Nonlinear sensors and effectors: The sensing array of the sensor may have non-uniform receptors (e.g.. like the retina where the density of cone and rod receptors in the fovea is higher than the periphery). For an effector, the muscle neurons are non-uniform. Like the uniform case, there is no need to calibrate. Simply connect pixels of new pattern uniformly across the old pattern. The DN will automatically assign neuronal resource according to the density distribution in the new pattern.

Change in computational resources: AOS distributes the additional resource, or strip the resource, uniformly across the entire Y zone. DN will automatically blend in new neurons or fill the holes left out by deleted neurons.

### REFERENCES

[1] J. S. Albus. A model of computation and representation in the brain. Information Science, 180(9):1519-1554, 2010.

[2] C. H. Anderson and D. C. Van Essen. Shifter circuits: A computational strategy for dynamic aspects of visual processing. Proc. Natl. Acad. Sci. USA, 84:6297-6301, September 1987.

[3] S. Arora. Polynomial time approximation schemes for euclidean traveling salesman and other geometric problems. Journal of the ACM, 45(5):753-782, 1998.

[4] E. A. Bates, J. L. Elman, M. H. Johnson, A. Karmiloff-Smith, D. Parisi, and K. Plunkett. Innateness and Emergentism: A Companion to Cognitive Science. Basil Blackwell, Oxford, 1998.

[5] G. Bi and M. Poo. Synaptic modification by correlated activity: Hebb's postulate revisited. Annual Review of Neuroscience, 24:139-166, 2001.

[6] C. Blakemore and G. F. Cooper. Development of the brain depends on the visual environment. Nature, 228:477-478, October 1970.

[7] T. J. Buschman and E. K. Miller. Top-down versus bottom-up control of attention in the prefrontal and posterior parietal cortices. Science, 315:1860-1862, 2007.

[8] J. Cho, N-. K. Yu, J-. H. Choi, S-. E. Sim, S. J. Kang, C. Kwak, S-. W. Lee, J-. I. Kim, D. I Choi, V. N. Kim, and B-. K. Kaang. Multiple repressive mechanisms in the hippocampus during memory formation. Science, 350:82-87, Oct. 2 2015.

[9] N. Chomsky. Rules and Representation. Columbia University Press, New York, 1978.

[10] M. Cole and S. R. Cole. The Development of Children. Freeman, New York, 3rd edition, 1996.

[11] M. Corbetta and G. L. Shulman. Control of goal-directed and stimulus-driven attention in the brain. Nature Reviews Neural Science, 3:201-215, 2002.

[12] T. Cukur, S. Nishimoto, A. G Huth, and J. L. Gallant. Attention during natural vision warps semantic representation across the human brain. Nature Neuroscience, 16:763-770, 2013.

[13] Y. Dan and M. Poo. Spike timing-dependent plasticity: From synapses to perception. Physiological Review, 86:1033-1048, 2006.

[14] N. D. Daw, S. Kakade, and P. Dayan. Opponent interactions between serotonin and dopamine. Neural Networks, 15(4-6):603-616, 2002.

[15] G. Deco and E. T. Rolls. A neurodynamical cortical model of visual attention and invariant object recognition. Vision Research, 40:2845-2859, 2004.

[16] R. Desimone and J. Duncan. Neural mechanisms of selective visual attention. Annual Review of Neuroscience, 18:193-222, 1995.

[17] C. Eliasmith, T. C. Stewart, X. Choo, T. Bekolay, T. DeWolf, Y. Tang, and D. Rasmussen. A large-scale model of the functioning brain. Science, 338:1202-1205, 2012.

[18] J. L. Elman, E. A. Bates, M. H. Johnson, A. Karmiloff-Smith, D. Parisi, and K. Plunkett. Rethinking Innateness: A connectionist perspective on development. MIT Press, Cambridge, Mass., 1997.

[19] J. L. Elman. Learning and development in neural networks: The importance of starting small. Cognition, 48(I):71-99, 1993.

[20] L. Fei-Fei. Visual recognition: Computational models and human psychophysics. Technical Report PhD thesis, California Institute of Technology, Pasadena, Calif., 2005.

[21] L. Fei-Fei. One-shot learning of object categories. IEEE Trans. Pattern Analysis and Machine Intelligence, 28(4):594-61 I, 2006.

[22] D. J. Felleman and D. C. Van Essen. Distributed hierarchical processing in the primate cerebral cortex. Cerebral Cortex, 1:1-47, 1991.

[23] M. B. Feller, D. P. Wellis, D. Stellwagen, F. S. Werblin, and C. J. Shatz. Requirement for cholinergic synaptic transmission in the propagation of spontaneous retinal waves. Science, 272(5265):1182-1187, 1996.

[24] P. Frasconi, M. God, M. Maggini, and G. Soda. Unified integration of explicit knowledge and learning by example in recurrent networks. IEEE Trans. on Knowledge and Data Engineering, 7(2):340-346, 1995.

[25] P. Frasconi, M. Gori, M. Maggini, and G. Soda. Representation of finite state automata in recurrent radial basis function networks. Machine Learning, 23:5-32, 2006.

[26] K. Fukushima. Cognitron: A self-organizing multilayered neural network. Biological Cybernetics, 20:121-136, 1975.

[27] K. Fukushima. Neocognitron: A self-organizing neural network model for a mechanism of pattern recognition unaffected by shift in position. Biological Cybernetics, 36:193-202, 1980.

[28] K. Fukushima, S. Miyake, and T. Ito. Neocognitron: A neural network model for a mechanism of visual pattern recognition. IEEE Trans. Systems, Man and Cybernetics, 13(5):826-834, 1983.

[29] E. Gibney. Google reveals secret test of Al bot to beat top Go players. Nature, 541(142):142, 2017.

[30] M. A. Gluck, E. Mercado, and C. Myers, editors. Learning and Memory: From Brain to Behavior. Worth Publishers, New York, 2nd edition, 2013.

[31] L. Gomes. Machine-learning maestro Michael Jordan on the delusions of big data and other huge engineering efforts. IEEE Spectrum, Online article posted Oct. 20, 2014.

[32] A. Graves and et al. Hybrid computing using a neural network with dynamic external memory. Nature, 538:471-476, 2016.

[33] A. Graves, G. Wayne, and I. Danihelka. Neural Turing machines. Technical report, Google DeepMind, London, UK, Dec. 10, 2014. arXiv:1410.5401.

[34] S. Grossbcrg and E. Mingolla. Neural dynamics of form perception: Boundary completion, illusory figures, and neon color spreading. Psychological Review, 92:173-211, 1985.

[35] Q. Guo, X. Wu, and J. Weng. Cross-domain and within-domain synaptic maintenance for autonomous development of visual areas. In Proc. the Fifth Joint IEEE International Conference on Development and Learning and on Epigenetic Robotics, pages +1-6, Providence, R.I., Aug. 13-16 2015.

[36] S. Hamad. The symbol grounding problem. Physica D, 42:335-346, 1990.

[37] S. Hamad. Debunking Eugene: Montreal cognitive scientist doubts UK university's Turing test claim. CBC Canada: As It Happens, Jun. 10 2014.

[38] M. Harris. Researchers hacks self-driving car sensors. IEEE Spectrum, Sep. 4 2015. online.

[39] G. E. Hinton, S. Osindero, and Y. W. Teh. A fast learning algorithm for deep belief nets. Neural Computation, 18:1527-1554, 2006.

[40] P. Holme and J. Saramaki. Temporal networks. Physics Reports, 519(3):97-125, Oct. 2012.

[41] J. E. Hoperoft, R. Motwani, and J. D. Ullman. Introduction to Automata Theory, Languages, and Computation. Addison-Wesley, Boston, Mass., 2006.

[42] H. T. Ito, S. J. Zhang, M. P. Witter, E. I. Moser, and M. B. Moser. A prefrontal??thalamo??hippocampal circuit for goal-directed spatial navigation. Nature, 522:50-55, 2015.

[43] L. Ltd and C. Koch. A saliency-based search mechanism for overt and covert shifts of visual attention. Vision Research, 40(10-12):1489-1506, 2000.

[44] L. Itti and C. Koch. Computational modelling of visual attention. Nature Reviews Neuroscience, 2:194-203, 2001.

[45] L. Itti, C. Koch, and E. Niebur. A model of saliency-based visual attention for rapid scene analysis. IEEE Trans. Pattern Analysis and Machine Intelligence, 20(11):1254-1259, November 1998.

[46] L. Itti, G. Rees, and J. K. Tsotsos, editors. Neurobiology of Attention. Elsevier Academic, Burlington, Mass., 2005.

[47] E. M. Izhikevich. Dynamical Systems in Neuroscience. MIT Press, Cambridge, Mass., 2007.

[48] E. M. Izhikevich, J. A. Gally, and G. M. Edelman. Spike-timing dynamics of neuronal groups. Cerebral Cortex, 14(8):933-944, 2004.

[49] Z. Ji and J. Weng. WWN-2: A biologically inspired neural network for concurrent visual attention and recognition. In Proc. IEEE Int'l Joint Conference on Neural Networks, pages +1-8, Barcelona, Spain, Jul. 18-23, 2010.

[50] M. I. Jordan and T. M. Mitchell. Machine learning: Trends, perspectives, and prospects. Science, 349:255-260, Jul. 17 2015.

[51] S. Kakade and P. Dayan. Dopamine: generalization and bonuses. Neural Network, 15:549-559, 2002.

[52] E. R. Kandel, J. H. Schwartz, and T. M. Jessell, editors. Principles of Neural Science. Appleton & Lange, Norwalk, Conn., 3rd edition, 1991.

[53] E. R. Kandel, J. H. Schwartz, and T. M. Jessell, editors. Principles of Neural Science. McGraw-Hill, New York, 4th edition, 2000.

[54] E. R. Kandel, J. H. Schwartz, T. M. Jessell, S. Siegelbaum, and A. J. Hudspeth, editors. Principles of Neural Science. McGraw-Hill, New York, 5th edition, 2012.

[55] A. Karpathy, G. Toderici, S. Shetty, T. Leung, R. Sukthankar, and Li Fei-Fei. Large-scale video classification with convolutional neural networks. In Proc. Computer Vision and Pattern Recognition, pages +1-8, Columbus, Ohio, Jun. 24-27, 2014.

[56] L. C. Katz and C. J. Shatz. Synaptic activity and the construction of cortical circuits. Science, 274(5290):1133-1138, 1996.

[57] C. Koch and S. Ullman. Shifts in selective visual attention: Towards the underlying neural circuitry. Human Neurobiology, 4:219-227, 1985.

[58] J. Krause, J. Johnson, R. Krishna, and Li Fei-Fei. A hierarchical approach for generating descriptive image paragraphs. Technical Report arXiv:1611.06607v1, Department of Computer Science, Stanford University, Stanford, Calif., Nov. 20, 2016.

[59] A. Krizhevsky, I. Sutskever, and G. Hinton. Imagenet classification with deep convolutional neural networks. In Advances in Neural Information Processing Systems 25, pages 1106-1114, 2012.

[60] B. M. Lake, R. Salakhutdinov, and J. B. Tenenbaum. Human-level concept learning through probabilistic program induction. Science, 350:1332-1338, 2016.

[61] Y. LeCun, L. Bengio, and G. Hinton. Deep learning. Nature, 521:436-444, 2015.

[62] Y. LeCun, L. Bottou, Y. Bengio, and P. Haffner. Gradient-based learning applied to document recognition. Proceedings of IEEE, 86(11):2278-2324, 1998.

[63] T. W. Lee, M. Girolami, and T. J. Sejnowski. Independent component analysis using an extended infomax algorithm for mixed sub-gaussian and super-gaussian sources. Neural Computation, 11(2):417-441, 1999.

[64] D. B. Lenat. CYC: A large-scale investment in knowledge infrastructure. Communications of the ACM, 38(11):33-38, 1995.

[65] W. Li, V. Piëch, and C. D. Gilbert. Perceptual learning and top-down influences in primary visual cortex. Nature Neuroscience, 7(6):651-657, 2004.

[66] Y. Li, D. Fitzpatrick, and L. E. White. The development of direction selectivity in ferret visual cortex requires early visual experience. Nature Neuroscience, 9:676-681, 2006.

[67] M. Luciw and J. Weng. Where What Network 3: Developmental top-down attention with multiple meaningful foregrounds. In Proc. IEEE Int'l Joint Conference on Neural Networks, pages 4233-4240, Barcelona, Spain, Jul. 18-23, 2010.

[68] J. C. Martin. Introduction to Languages and the Theory of Computation. McGraw Hill, New York, 4th edition, 2011.

[69] N. Masuda, K. KLemm, and V. M. Egufluz. Temporal networks: Slowing down diffusion by long lasting interactions. Physics Review Letters, 111(18):97-125, November 2013.

[70] J. L. McClelland. The interaction of nature and nurture in development: A parallel distributed processing perspective. In P. Bertelson, P. Eelen, and G. d'Ydewalle, editors, International Perspectives on Psychological Science, volume 1: Leading Themes, pages 57-88. Erlbaum, Hillsdale, N.J., 1994.

[71] J. L. McClelland, D. E. Rumelhart, and The PDP Research Group, editors. Parallel Distributed Processing, volume 2. MIT Press, Cambridge, Mass., 1986.

[72] M. Minsky. Logical versus analogical or symbolic versus connectionist or neat versus scruffy. A1 Magazine, 12(2):34-51, 1991.

[73] V. Mnih and et al. Human-level control through deep reinforcement learning. Nature, 518:529-533, 2015.

[74] P. R. Montague, P. Dayan, C. Person, and T. J. Sejnowski. Bee foraging in uncertain environments using predictive Hebbian learning. Nature, 377:725-728, 1995.

[75] J. Moran and R. Desimone. Selective attention gates visual processing in the extrastrate cortex. Science, 229(4715):782-784, 1985.

[76] V. Müller. The hard and easy grounding problems. AMD Newsletter, 7(I):8-9, 2010.

[77] J. O'Keefe and D. H. Conway. Hippocampal place units in the freely moving rat: Why they fire where they fire. Experimental Brain Research, 31:573-590, 1978.

[78] J. O'Keefe and J. Dostrovsky. The hippocampus as a spatial map: Preliminary evidence from unit activity in the freely-moving rat. Brain Research, 34(1):171-175, 1971.

[79] B. A. Olshausen, C. H. Anderson, and D. C. Van Essen. A neurobiological model of visual attention and invariant pattern recognition based on dynamic routing of information. Journal of Neuroscience, 13(11):4700-4719, 1993.

[80] B. A. Olshaushen and D. J. Field. Emergence of simple-cell receptive field properties by learning a sparse code for natural images. Nature, 381:607-609, Jun. 13, 1996.

[81] C. W. Omlin and C. L. Giles. Constructing deterministic finite-state automata in recurrent neural networks. Journal of the ACM, 43(6):937-972, 1996.

[82] J. Pearl. Fusion, propagation, and structuring in belief networks. Artificial Intelligence, 29:241-288, 1986.

[83] J. Piaget. The Construction of Reality in the Child. Basic Books, New York, 1954.

[84] S. Pinker. How the Mind Works. W W Norton, New York, 2009.

[85] M. I. Posner, C. R. R. Snyder, and B. J. Davison. Attention and the detection of signals. Journal of Experimental Psychology: General, 109:160-174, 1980.

[86] M. L. Puterman. Markov Decision Processes. Wiley, New York, 1994.

[87] S. Quartz and T. J. Sejnowski. The neural basis of cognitive development: A constructivist manifesto. Behavioral and Brain Sciences, 20(4):537-596, 1997.

[88] L. R. Rabiner, L. G. Wilpon, and F. K. Soong. High performance connected digit recognition using hidden Markov models. IEEE Trans. Acoustics, Speech and Signal Processing, 37:1214-1225, August 1989.

[89] L. Reddy, F. Moradi, and C. Koch. Top-down biases win against focal attention in the fusiform face area. Neuroimage, 38:730-739, 2007.

[90] M. Riesenhuber and T. Poggio. Hierarchical models of object recognition in cortex. Nature Neuroscience, 2(11):1019-1025, 1999.

[91] M. Riesenhuber and T. Poggio. Neural mechanisms of object recognition. Current Opinion in Neurobiology, 12(2):162-168, 2002.

[92] D. E. Rumelhart, J. L. McClelland, and the PDP Research Group. Parallel Distributed Processing, volume 1. MIT Press, Cambridge, Mass., 1986.

[93] S. Russell and P. Norvig. Artificial Intelligence: A Modern Approach. Prentice-Hall, Upper Saddle River, N.J., 2nd edition, 2003.

[94] S. Russell and P. Norvig. Artificial Intelligence: A Modern Approach. Prentice-Hall, Upper Saddle River, N.J., 3rd edition, 2010.

[95] Y. B. Saalmann, I. N. Pigarev, and T. R. Vidyasagar. Neural mechanisms of visual attention: How top-down feedback highlights relevant locations. Science, 316:1612-1615, 2007.

[96] P. Salin and J. Bullier. Corticocortical connections in the visual system: Structure and function. Physiological Reviews, 75(1):107-154, 1995.

[97] A. P. Saygin, I. Cicekli, and V. Akman. Turing test: 50 years later. Minds and Machines, 10(4):463-518, 2000.

[98] J. Schmidhuber. Deep learning in neural networks: An overview. Technical Report IDSIA-03-14, The Swiss AI Lab IDSIA, Manno-Lugano, Switzerland, Oct. 8 2014.

[99] J. Schmidhuber. Deep learning in neural networks: An overview. Neural Networks, 61:85-117, 2015.

[100] R. Scriven, G. Amiot-Cadey, and Collins. Collins French grammar. HarperCollins, Glasgow, 2011.

[101] T. Serre, M. Kouh, C. Cadieu, U. Knoblich, G. Kreiman, and T. Poggio. A theory of object recognition: Computations and circuits in the feedforward path of the ventral) stream in primate visual cortex. Technical Report Al Memo 2005-036, Center for Biological and Computational Learning, McGovern Institute for Brain Research, Computer Science and Artificial Intelligence Laboratory, Department of Brain and Cognitive Sciences, MIT, Cambridge, Mass., 2005.

[102] T. Serre, L. Wolf, S. Bileschi, M. Riesenhuber, and T. Poggio. Robust object recognition with cortex-like mechanisms. IEEE Trans. Pattern Analysis and Machine Intelligence, 29(3):411-426, 2007.

[103] J. Sharma, A. Angelucci, and M. Sur. Induction of visual orientation modules in auditory cortex. Nature, 404:841-847, 2000.

[104] H. T. Siegelmann. Computation beyond the Turing limit. Science, 286:545-548, 1995.

[105] H. T. Siegelmann and E. D. Sontag. On the computational power of neural nets. Journal of Computer and System Sciences, 50(1):132-150, 1995.

[106] M. Solgi, T. Liu, and J. Weng. A computational developmental model for specificity and transfer in perceptual learning. Journal of Vision, 13(1):ar. 7, pp. 1-23, 2013.

[107] M. Solgi and J. Weng. Developmental stereo: Emergence of disparity preference in models of visual cortex. IEEE Trans. Autonomous Mental Development, 1(4):238-252, 2009.

[108] M. Solgi and J. Weng. WWN-8: Incremental online stereo with shape-from-x using life-long big data from multiple modalities. In Proc. INNS Conference on Big Data, pages 316-326, San Francisco, Calif., Aug. 8-10, 2015.

[109] R. Sun. The importance of cognitive architectures: An analysis based on CLARION. Journal of Experimental and Theoretical Artificial Intelligence, 19:159-193, 2007.

[110] R. Sun, P. Slusarz, and C. Terry. The interaction of the explicit and the implicit in skill learning: A dual-process approach. Psychological Review, 112(1):59-192, 2005.

[111] M. Sur and J. L. R. Rubenstein. Patterning and plasticity of the cerebral cortex. Science, 310:805-810, 2005.

[112] R. S. Sutton and A. Barto. Reinforcement Learning. MIT Press, Cambridge, Mass., 1998.

[113] A. M. Treisman. A feature-integration theory of attention. Cognitive Science, 12(1):97-136, 1980.

[114] A. M. Treisman. Features and objects in visual processing. Scientific American, 255(5):114-125, 1986.

[115] J. K. Tsotsos. A ‘complexity level’ analysis of immediate vision. International Journal of Computer Vision, 1(4):303-320, 1988.

[116] J. K. Tsotsos, S. M. Culhane, W. Y. K. Wai, Y. Lai, N. Davis, and F. Nuflo. Modeling visual attention via selective tuning. Artificial Intelligence, 78:507-545, 1995.

[117] A. M. Turing. On computable numbers with an application to the Entscheidungsproblem. Proc. London Math. Soc., 2nd series, 42:230-265, 1936. A correction, ibid., 43, pp. 544-546.

[118] L. G. Valiant. A theory of the learnable. Communications of the ACM, 27(1 1):1134-1142, November 1984.

[119] L. G. Valiant. A neuroidal architecture for cognitive computation. Journal of the ACM, 47(5):854-882, September 2000.

[120] L. VonMelchner, S. L. Pallas, and M. Sur. Visual behaviour mediated by retinal projections directed to the auditory pathway. Nature, 404:871-876, 2000.

P. Voss. Sensitive and critical periods in visual sensory deprivation. Frontiers in Psychology, 4:664, 2013. doi: 10.3389/fp-syg.2013.00664.

[122] L. S. Vygotsky. Thought and language. MIT Press, Cambridge, Mass., 1962. trans. E. Hanfmann & G. Vakar.

[123] Y. Wang, X. Wu, and J. Weng. Synapse maintenance in the where-what network. In Proc. Int'l Joint Conference on Neural Networks, pages 2823-2829, San Jose, Calif., Jul. 31- Aug. 5, 2011.

[124] C. Watkins and P. Dayan. Q-learning. Machine Learning, 8:279-292, 1992.

[125] J. Weng. Task muddiness, intelligence metrics, and the necessity of autonomous mental development. Minds and Machines, 19(1):93-115, 2009.

[126] J. Weng. Why have we passed “neural networks do not abstract well”? Natural Intelligence: the INNS Magazine, 1(1):13-22, 2011.

[127] J. Weng. Natural and Artificial Intelligence: Introduction to Computational Brain-Mind. BMI Press, Okemos, Mich., 2012.

[128] J. Weng. Symbolic models and emergent models: A review. IEEE Trans. Autonomous Mental Development, 4(1):29-53, 2012.

[129] J. Weng. How the brain-mind works: A two-page introduction to a theory. Brain-Mind Magazine, 2(2):1-3, 2013.

[130] J. Weng. A bridge-islands model for brains: Developing numeric circuits for logic and motivation. In Proc. International Joint Conference on Neural Networks, pages +1-8, Beijing, Jul. 7-13 2014.

[131] J. Weng. Brain as an emergent finite automaton: A theory and three theorems. International Journal of Intelligent Science, 5(2):l 12-131, 2015. received Nov. 3, 2014 and accepted by Dec. 5, 2014.

[132] J. Weng, N. Ahuja, and T. S. Huang. Cresceptron: a self-organizing neural network which grows adaptively. In Proc. Int'l Joint Conference on Neural Networks, volume 1, pages 576-581, Baltimore, Md., June 1992.

[133] J. Weng, N. Ahuja, and T. S. Huang. Learning recognition and segmentation of 3-D objects from 2-D images. In Proc. IEEE 4th hug Conf. Computer Vision, pages 121-128, May 1993.

[134] J. Weng, N. Ahuja, and T. S. Huang. Learning recognition and segmentation using the Cresceptron. International Journal of Computer Vision, 25(2):109-143, November 1997.

[135] J. Weng and M. Luciw. Dually optimal neuronal layers: Lobe component analysis. IEEE Trans. Autonomous Mental Development, 1(1):68-85, 2009.

[136] J. Weng and M. D. Luciw. Brain-inspired concept networks: Learning concepts from cluttered scenes. IEEE Intelligent Systems Magazine, 29(6):I4-22, 2014.

[137] J. Weng, J. McClelland, A. Pentland, O. Sporns, I. Stockman, M. Sur, and E. Thelen. Autonomous mental development by robots and animals. Science, 291(5504):599-600, 2001.

[138] T. N. Wiesel and D. H. Hubei. Comparison of the effects of unilateral and bilateral eye closure on cortical unit responses in kittens. Journal of Neurophysiology, 28: 1029-1040, 1965.

[139] D. J. Wood, J. S. Bruner, and G. Ross. The role of tutoring in problem-solving. Journal of Child Psychology and Psychiatry, pages 89-100, 1976.

[140] X. Wu and J. Weng. Actions as contests. In Proc. International Joint. Conf Neural Networks, pages +1-8, Anchorage, Ak., May 14-19, 2017. IEEE Press.

[141] X. Wu and J. Weng. Actions as contexts. In Proc. International Joint Conference on Neural Networks, pages 214-221, Anchorage, Ak., May 14-17 2017.

[142] J. You. Beyond the Turing Test. Science, 247(6218):116, January 2015.

[143] A. J. Yu and P. Dayan. Uncertainty, neuromodulation, and attention. Neuron, 46:681-692, 2005.

### VI. APPENDIX

This appendix presents the AOS format for the Setting Files about the “life” of a machine agent-body and extra-body environment. Each machine body typically has a different set of sensors, effectors, and computational resources. For the AOS, not all the body information is needed for the AOS Setting Files, only very minimal, thanks to the AOS capability for auto-programming for general purposes. Each life needs also other information about the extra-body environment—batch, virtual, or grounded. The AOS Setting File needs only minimal information in the Setting File for the machine agent to “live” (learn and perform). In summary, the AOS Setting File, or simply Setting File, is a text file that provides body-specific parameters about sensors (S), effectors (E), computational resources (C) and other (0) in a required format. In particular, the order of each line is important at the current release as well as for checking possible errors. This document only provides some examples of this invention. The definition of the Setting File is extendable.

In addition, AOS also provides a graphic user interface (GUI) that allows a user to enter the parameters of the Setting File through interactions, suitable for beginners. The GUI provides system prompts, helps, parameter fields, the default values, and checks for the validity of the entered data. This GUI produces a Setting File and minimizes possible format errors in the otherwise hand entered parameters from a few templates of Setting Files.

We first present a glossary of terms used in the AOS Setting File.

### A. Glossaries

All parameters in the Setting File fall into four categories, sensors (S), effectors (E), computational resources (C), and others (O).
Sensor Layer: DN layers that directly link with sensors.
Hidden Layer: DN layers that are neither sensor layers nor motor layers. Such layers are hidden inside the skull.
Motor Layer: DN layers that directly link with effectors. DN generates output through Motor Layers. The skull-external environment can also supervise Motor Layers to teach DN.
Height and width of Sensor Layer & Motor Layer: A user can view the input from each sensor and input from each effector as an image. These parameters specify the width and height of such images.
TopK winner: The number of neurons allowed to fire within each competition zone of each neuron.
Type of Y neurons: This is only applicable to DN-2 and above: Each Y region is specified by a connection type: (x, y, x) where x, y, z are binary, representing the region is connected with X, Y, and Z area or not, respectively.
Growth rate: The speed of neuronal growth in the area based on the goodness of the best matched neuron in the area.
Prescreen: Prescreen the bottom-up or top-down match for each hidden neuron so that a neuron that has a weak bottom-up match or top-down match is not allowed to participate in the competition.
Network ID: To distinguish a different network the user wants to train and save.
DN Version: The version number of DN. Currently, 1 for DN-1 and 2 for DN-2. A higher number is allowed when higher versions of DN have been released. DN-1 is older than DN-2 and is a special case of DN-2.
Mode of environment: In all the modes of environment below, the DN always runs incrementally. At each frame time, the DN always tries to generate an action, but the action is overwritten by the environment if the environment intends to supervise (teach) the action. Otherwise, the DN performs.
   1) B for batch environment. This mode is used for debugging or contests. Must specify DataAd-dress about an existing data stream that will be fed into DN as the teaching and testing environment. In this mode, the training is not sensorimotor recursive—the sensory data are not a function of agent actions because the training data are collected upfront without knowing the agent actions.
   2) S for simulation environment. In this mode, the user must provide a simulated (virtual) extra-body environment in which the learning agent lives. This mode can be used for debugging and contest like the batch data mode but is further sensorimotor recursive—in the virtual extra-body environment the sensory input for the next time frame depends on the output actions from the learning agent at the current time frame. A major difference between the simulation mode here and the grounded mode below is that the frame time is virtual: The waiting between the extra-body environment and the agent is two-way: The simulated extra-body environment can wait for the agent to compute and produce the current actions; the learning agent can wait for the virtual extra-body environment to complete its update using the agent current actions before taking the next sensory input.
   3) G for grounded (real-world) environment. Put the DN learning agent in a real-world extra-body environment. In this running mode, the learning agent must have a physical body with real sensors and real effectors. The time is real: both the real world and the learning agent do not wait each other. The learning agent can naturally take into account of the effects of the real time delays caused by the time of DN update and the delays caused by the speed of agent body's actions and sensing. In the above S mode, it is challenging for a simulated virtual environment to faithfully simulate such real time delays in the real world because any computer simulation of the real world is always partial and incomplete.
Receptive field: Hidden neurons only take in signal transmitted from sensory neurons located in receptive field.
   size: Each receptive field of a neuron is a square of the size, in the unit of the number of pixels or receptors. The spatial distribution of pixels or receptors does not need to be uniform (like in the retina of a human eye) because the size is measured in the number of pixels or receptors.
   stride: The interval between two receptive fields, also in the unit of the number of pixels or receptors.
Sensory modality: Can choose one or more of the following 5 types.
   1) Vi: Vision
      a) Le: Left Eye
      b) Re: Right Eye
      c). Se: Single Eye
   2) Au: Audition
      a) Le: Left Ear
      b) Re: Right Ear
      c) Se: Single Ear
   3) To: Touch. All symbolic input devices can use this modality.
      a) Ak: American Keyboard, keyboard layout catering to American keyboard specifications
      b) Ck: Chinese Keyboard, keyboard layout catering to Chinese keyboard specifications
      c) GPS: GPS inputs as touch
   4) Ta: Taste
   5) Sm: Smell

The first release of AOS includes the Setting File standard for DN-1 version for compatibility purposes.

### B. Examples of Setting Files

A user can enter the parameters by altering some of the Setting Files below. Alternatively, the user may generate a Setting File through the AOS Graphic User Interface (GUI) that provides the default value for each parameter and interactively asks the user to enter value and then check the validity of the entered value.

1) DN-1: Vision Example: The following is an example of autonomous navigator agent using a single camera. It has four motor areas, representing action, where, attention scale, and heading, respectively.

% AOS RELEASE Version 1.0

| | |
|---|---|
| 1 | \\ O: DN Version |
| B | \\ O: Environment Mode |
| VisionDataFile | \\ O: Batch Data Address as file name |
| 1 | \\ Number of Sensors |
| Vi:Se | \\ C: Modality of SensorLayer1: vision, single camera |
| 38 38 1 | \\ S: (Height, width, depth) of SensorLayer1 |
| 4 | \\ E: Number of MotorLayers |
| 1 6 | \\ E: (Height, width) of MotorLayer1: action |
| 11 4 | \\ E: (Height, width) of MotorLayer2: desired direction |
| 1 6 | \\ E: (Height, width) of MotorLayer3: attention motor |
| 1 4 | \\ E: (Height, width) of MotorLayer4: type of landmark |
| 1 1 1 1 | \\ C: TopK winning neurons for each MotorLayer |
| 1 | \\ C: Number of neurons of HiddenLayers |
| 2000 | \\ C: Maximum number of HiddenLayer neurons |
| | allowed |
| 1 | \\ C: TopK winning neurons of HiddenLayer |

2) DN-1: Audition Example: The following is an audition agent using a single microphone. It has two motor areas, one is the dense phone pattern, the other is the sparse phone type.

% AOS RELEASE Version 1.0

| | |
|---|---|
| 1 | \\ O: DN Version |
| B | \\ O: Environment Mode |
| AuditonDataFile | \\ O: Batch Data Address as file name |
| 1 | \\ Number of Sensors |
| Au:Se | \\ C: Modality: audition, single ear |
| 1 89 1 | \\ S: (Height, width, depth) of SensorLayer1 |
| 2 | \\ E: Number of MotorLayers |

| | |
|---|---|
| 1 46 | \\ E: (Height, width) of MotorLayer1: type of phone |
| 1 177 | \\ E: (Height, width) of MotorLayer2: dense pattern of X clusters |

| | |
|---|---|
| 1 1 | \\ C: TopK winning neurons for each MotorLayer |
| 1 | \\ C: Number of neurons of HiddenLayers |
| 330 | \\ C: Maximum number of HiddenLayer neurons |
| | allowed |
| 1 | \\ C: TopK winning neurons of HiddenLayer |

3) DN-1: Natural Language Example: The following is a natural language using a single touch sensor, learning two natural languages in a bilingual environment. Each sensory vector is a 12-dimensional binary vector. The agent has two motor areas, one is the type of language (1: Neutral; 2: English, 3: French), the other is a context-state vector: 17 dimensional in which 5 neurons fire at 1 and all others do not fire. These effectors were taught to understand (both partial and full) single sentences each of which has two versions: English and French.

% AOS RELEASE Version 1.0

| | |
|---|---|
| 1 | \\ O: DN Version |
| B | \\ O: Environment Mode |
| LanguageDataFile | \\ O: Batch Data Address as file name |
| 1 | \\ Number of Sensors |
| To | \\ C: Modality: touch, |
| 1 12 1 | \\ S: (Height, width, depth) of SensorLayer1 |
| 2 | \\ E: Number of MotorLayers |
| 1 17 | \\ E: (Height, width) of MotorLayer1: state pattern |
| 1 3 | \\ E: (Height, width) of MotorLayer2: type of |
| | language |
| 5 1 | \\ C: TopK winning neurons for each MotorLayer |
| 1 | \\ C: Number of neurons of HiddenLayers |
| 5145 | \\ C: Maximum number of HiddenLayer neurons |
| | allowed |
| 1 | \\ C: TopK winning neurons of HiddenLayer |

The following sections provide DN-2 Setting File examples. All the examples above can change DN version to 2 to run DN-2.

4) DN-2: Maze as a Sensorimotor Recursive Environment: This example is sensorimotor recursive because the next sensory input is impossible without producing the current action first.

% AOS RELEASE Version 1.0

| | |
|---|---|
| 2 | \\ O: DN Version |
| S | \\ O: Environment Mode: Simulation |
| VitualMazeProgram | \\ O: Environmental simulation program as file name |
| 3 | \\ S: Number of Sensors |
| Vi | \\ C: Modality for Sensor1: vision, |
| 30 43 3 | \\ S: (Height, width, depth) of SensorLayer1 : 3 for rgb |
| To | \\ C: Modality for Sensor2: touch |
| 1 4 1 | \\ S: (Height, width, depth) of SensorLayer2 |
| To | \\ C: Modality for Sensor3: touch: ground tiles |
| 1 3 1 | \\ S: S: (Height, width, depth) of SensorLayer1 |
| 10 | \\ E: Number of MotorLayers |
| 1 4 | \\ E: (Height, width) of MotorLayer1: action |
| 1 8 | \\ E: (Height, width) of MotorLayer2: skill |
| 1 3 | \\ E: (Height, width) of MotorLayer3: means |
| 1 15 | \\ E: (Height, width) of MotorLayer4: cost 1 |
| 1 15 | \\ E: (Height, width) of MotorLayer5: cost 2 |
| 1 4 | \\ E: (Height, width) of MotorLayer6: compare |

| | |
|---|---|
| 1 3 | \\ E: (Height, width) of MotorLayer7: covert: speak/think/none |
| 1 3 | \\ E: (Height, width) of MotorLayer8: EyeOpen: open/close/none |
| 1 3 | \\ E: (Height, width) of MotorLayer9: GoBackCost1: Yes/no/none |
| 1 3 | \\ E: (Height, width) of MotorLayer9: GoBackCost2: Yes/no/none |

| | |
|---|---|
| 1 1 1 1 1 1 1 1 1 | \\ E: TopK winning of MotorLayers |
| 1 | \\ C: Number of HiddenLayers |
| 600 | \\ C: Number of HiddenLayer neurons |
| 0.5 | \\ C: Pre-screening percent |
| 15 1 | \\ C: (Size, stride) of receptive field in hidden layers |
| 0 0 0 0 2 0 0 | \\ C: number of Y layers of type, 001, 010, . . . , 110, 111 |
| GrowthRateTable.txt | \\ C: Address of growth rate table as file name |
| MeanValueTable.csv | \\ C: Address of mean value table as file name |

### C. DN-2: Vision from Batch Environment

% AOS RELEASE Version 1.0

| | |
|---|---|
| 2 | \\ O: DN Version |
| B | \\ O: Environment Mode: Batch |
| BatchVision | \\ O: Environmental batch vision program as file name |
| 1 | \\ S: Number of Sensors |
| Vi:Se | \\ C: Modality for Sensorl: vision, single eye |
| 30 40 1 | \\ S: (Height, width, depth) of SensorLayer1 : 1 for b/w |
| 5 | \\ E: Number of MotorLayers |
| 1 6 | \\ E: (Height, width) of MotorLayer1: action |
| 1 4 | \\ E: (Height, width) of MotorLayer2: gps |
| 1 1200 | \\ E: (Height, width) of MotorLayer3: where |
| 1 6 | \\ E: (Height, width) of MotorLayer4: what |
| 1 2 | \\ E: (Height, width) of MotorLayer5: scale |
| 1 1 1 1 1 | \\ E: TopK winning of MotorLayers |
| 1 | \\ C: Number of HiddenLayers |
| 600 | \\ C: Number of HiddenLayer neurons |
| 0.5 | \\ C: Pre-screening percent |
| 5 2 | \\ C: (Size, stride) of receptive field in hidden layers |
| 0 0 0 0 2 0 0 | \\ C: number of Y layers of type, 001, 010, . . . , 110, 111 |
| GrowthRateTable.txt | \\ C: Address of growth rate table as file name |
| MeanValueTable.csv | \\ C: Address of mean value table as file name |

1) DN-2: Vision Grounded: The following is an example of stereo vision based navigation, grounded in the real physical world.

% AOS RELEASE Version 1.0

| | |
|---|---|
| 2 | \\ O: DN Version |
| G | \\ O: Environment Mode: Grounded |
| GroundedVision | \\ O: Environmental steroe vision program as file name |
| 2 | \\ S: Number of Sensors |
| Vi:Le | \\ C: Modality for Sensor1: vision, left eye |
| 30 40 3 | \\ S: (Height, width, depth) of SensorLayer1 : 3 for RGB |
| Vi:Re | \\ C: Modality for Sensor1: vision, right eye |
| 30 40 3 | \\ S: (Height, width, depth) of SensorLayer1 : 3 for RGB |
| 5 | \\ E: Number of MotorLayers |
| 1 6 | \\ E: (Height, width) of MotorLayer1: action |

| | |
|---|---|
| 1 4 | \\ E: (Height, width) of MotorLayer2: GPS: forwd, left, right, arriv |

| | |
|---|---|
| 1 1200 | \\ E: (Height, width) of MotorLayer3: where |
| 1 6 | \\ E: (Height, width) of MotorLayer4: what |
| 1 2 | \\ E: (Height, width) of MotorLayer5: scale |
| 1 1 1 1 1 | \\ E: TopK winning of MotorLayers |
| 1 | \\ C: Number of HiddenLayers |
| 600 | \\ C: Number of HiddenLayer neurons |
| 0.5 | \\ C: Pre-screening percent |
| 5 2 | \\ C: (Size, stride) of receptive field in hidden layers |
| 0 0 0 0 2 0 0 | \\ C: number of Y layers of type, 001, 010, . . . , 110, 111 |
| GrowthRateTable.txt | \\ C: Address of growth rate table as file name |
| MeanValueTable.csv | \\ C: Address of mean value table as file name |

2) DN-2: Audition: The following is an example of audition for phone recognition. The size of receptive field to be 0 means full connection between the input frame in X and a Y neuron. The stride to be 0 means no stride is needed because of the full connection.

% AOS RELEASE Version 1.0

| | |
|---|---|
| 2 | \\ O: DN Version |
| B | \\ O: Environment Mode: Batch |
| AuditonDataFile | \\ O: Batch Data Address as file name |
| 1 | \\ S: Number of Sensors |
| Au:Se | \\ S: Modality: audition, single ear |
| 11 10 1 | \\ S: (Height, width, depth) of SensorLayer1: feature pattern |
| Au:Se | \\ S: Modality: audition, single ear |
| 10 8 1 | \\ S: (Height, width, depth) of SensorLayer2: volume pattern |

| | |
|---|---|
| 3 | \\ E: Number of MotorLayers |
| 1 46 | \\ E: (Height, width) of MotorLayer1: type of phone |
| 1 800 | \\ E: (Height, width) of MotorLayer2: dense pattrns of sensry clsters |
| 1 4 | \\ E: (Height, width) of MotorLayer3: volume |
| 1 1 1 | \\ E: TopK winning of MotorLayers |

| | |
|---|---|
| 1 | \\ C: Number of HiddenLayers |
| 1400 | \\ C: Number of HiddenLayer neurons |
| 0.5 | \\ C: Pre-screening percent |
| 0 0 | \\ C: (Size, stride) of receptive field in hidden layers |
| 0 0 0 2 2 0 0 | \\ C: number of Y layers of type, 001, 010, . . . , 110, 111 |

| | |
|---|---|
| GrowthRateTable.txt | \\ C: Address of growth rate table as file name |
| MeanValueTable.csv | \\ C: Address of mean value table as file name |

3) DN-2: Language: The following is an example of language understanding in a bilingual environment, for understanding each single sentence at a time.

% AOS RELEASE Version 1.0

| | |
|---|---|
| 2 | \\ O: DN Version |
| B | \\ O: Environment Mode: Batch |
| LanguageDataFile | \\ O: Batch Data Address as file name |
| 1 | \\ S: Number of Sensors |
| To | \\ S: Modality for Sensor1: touch, |
| 1 12 1 | \\ S: (Height, width, depth) of SensorLayer1 |
| 2 | \\ E: Number of MotorLayers |
| 1 17 | \\ E: (Height, width) of MotorLayer1: state pattern |
| 1 3 | \\ E: (Height, width) of MotorLayer2: type of |
| | language |
| 5 1 | \\ E: TopK winning of MotorLayers |
| 1 | \\ C: Number of HiddenLayers |
| 5145 | \\ C: Number of HiddenLayer neurons |
| 0.5 | \\ C: Pre-screening percent |

| | |
|---|---|
| 0 0 | \\ C: (Size, stride) of receptive field in hidden layers |
| 0 0 0 0 2 0 0 | \\ C: number of Y layers of type, 001, 010, . . . , 110, 111 |

| | |
|---|---|
| GrowthRateTable.txt | \\ C: Address of growth rate table as file name |
| MeanValueTable.csv | \\ C: Address of mean value table as file name |

To assist understanding, we provide some additional information below about the growth rates and mean weight threshold of DN. They are automatically generated by the DN core, based on each type of computer hardware. The AOS users do not need to know such details.

### D. An Example of the Growth Rate Table

| Rate | type001 | type010 | type011 | type100 | type101 | type110 | type111 |
|---|---|---|---|---|---|---|---|
| 0.02 | 0.001 | 0.001 | 0.001 | 0.001 | 1.0 | 0.001 | 0.001 |
| 0.04 | 0.001 | 0.001 | 0.001 | 0.001 | 1.0 | 0.001 | 0.001 |
| 0.06 | 0.001 | 0.001 | 0.001 | 0.001 | 1.0 | 0.001 | 0.001 |
| . . . | . . . | . . . | . . . | . . . | . . . | . . . | . . . |
| 1.00 | 0.001 | 0.001 | 0.001 | 0.001 | 1.0 | 0.001 | 0.001 |

First column: Rate of the number of used hidden neurons over the total number of allocated hidden neurons.
Other columns: Each neuron type's growth rate. The larger the value, the faster the growth.

### E. An Example of the MeanValue Rate Table

| Rate | meanValue |
|---|---|
| 0.05 | 0.01 |
| 0.1 | 0.01 |
| 0.15 | 0.01 |
| 0.2 | 0.01 |
| 0.25 | 0.01 |
| 0.3 | 0.01 |
| 0.35 | 0.01 |
| 0.4 | 0.01 |
| 0.45 | 0.01 |
| 0.5 | 0.01 |
| 0.55 | 0.01 |
| 0.6 | 0.01 |
| 0.65 | 0.01 |
| 0.7 | 0.01 |
| 0.75 | 0.01 |
| 0.8 | 0.01 |
| 0.85 | 0.01 |
| 0.9 | 0.01 |
| 0.95 | 0.01 |
| 1 | 0.01 |

The first column: The rate of the number of used hidden neurons over the total number of allocated hidden neurons
The second column: Each neuron type's mean weight threshold under specific percentage value, used to adjust each neuron's lateral response. The lower the value, the more lateral response is suppressed.

### ACKNOWLEDGMENTS

J. W. originated the ideas and concepts of the AOS as well as the principles and designs of the Setting Files. Others contributed to the experiments and discussions: Z. Z. vision and maze settings and experiments; X. W. audition settings and experiments as well as the language settings; J. L. C. natural languages settings and experiments; S. Z.: AOS technical supports for those Settings Files.

1) A method for auto-programming for general purposes.

2) A computing processor in claim 1 is either a Central Processing Unit (CPU), a Graphic Processing Unit (GPU), a Field Programmable Gate Array (FPGA), or an Application Specific Integrated Circuit (ASIC) System on Chip (SOC).

3) An artificial neural network of claim 1 characterized by at least four of the eight characteristics in acronym GENISAMA: Grounded, Emergent, Natural, Incremental, Skulled, Attentive, Motivated, Abstractive.

4) An artificial neural network of claim 1 which learns a Finite Automaton that acts as a control of any arbitrary Emergent Universal Turing Machine.

5) A method of claim 1 for treating a teacher, either living biological or nonliving objects, for an artificial neural network to imitate based on its motor inputs and its sensory inputs as an Emergent Universal Turing Machine.

6) A method of claim 5 for treating two parts in a unified (non-separate) way through network's attention for a cluttered scene either at the same time or at different times, where the two parts are (a) instructions and (b) data to which the instructions apply and on a tape of a traditional Universal Turing Machine (a) and (b) must be separate using a special encoding.

7) A presentation of a motor vector of claim 1 that corresponds to a combination of states and actions of an arbitrary Emergent Universal Turing Machine.

8) A presentation of a motor vector of claim 1 that corresponds to a combination of elements in a hierarchy of knowledge for one or a multiplicity of multiple open-ended tasks executed by an arbitrary Emergent Universal Turing Machine.

9) An initialization of neurons in claim 5 is one sensor-motor observation at a time until all available neurons have been initialized for one or a multiplicity of multiple open-ended tasks executed by an arbitrary Emergent Universal Turing Machine.

10) A neuronal update of claim 5 where the update is always optimal in the sense of maximal likelihood, conditioned on its limited computational resources and its learned experience for one or a multiplicity of multiple open-ended tasks executed by any arbitrary Emergent Universal Turing Machine.

11) An operating system of claim 1 for auto-programming for general purposes that sits between a conventional operating system and an artificial neural network so that a learning engine automatically adapts to a system body comprising of sensors, effectors, and computational resources.

12) A setting file of claim 11 that defines an open-ended set of parameters to serve as an expandable body setting standard for each system body to inform the operating system in claim 11.

13) A representation of claim 11 where all effectors are unified as a vector.

14) A representation of claim 11 where all sensors are unified as a vector.

15) A representation of claim 11 where all computational elements are unified as a set of neurons.

16) A representation of claim 11 where one or a multiplicity of sensors, effectors, and computational resources are allowed to change during a lifelong learning.

17) A representation of claim 11 where neuronal resolutions can be non-uniform in that neurons that directly connect with sensors or effectors do not cover an area of the same scale.

18) A representation of claim 1 for natural language understanding that uses action vectors to represent language contexts and uses sensory vectors to represent words for an acquisition of a single or a multiplicity of natural languages.

19) An apparatus of claim 1.

20) An apparatus of claim 1 for one or a multiplicity of three types of systems: vision, audition, and natural language understanding.
